(19) United States
(12) Patent Application Publication
(10) Pub. No.: US 2026/0113217 A1
(43) Pub. Date: Apr. 23, 2026

(54) COMMUNICATION METHOD AND RELATED APPARATUS

(71) Applicant: Huawei Technologies Co., Ltd., Shenzhen (CN)

(72) Inventors: Yiqun Ge, Ottawa (CA); Xiaoyan Bi, Shanghai (CN); Wuxian Shi, Ottawa (CA); Jianglei Ma, Ottawa (CA)

(21) Appl. No.: 19/411,975

(22) Filed: Dec. 8, 2025

Related U.S. Application Data
(63) Continuation of application No. PCT/CN2023/117860, filed on Sep. 8, 2023.
(60) Provisional application No. 63/507,208, filed on Jun. 9, 2023.

(51) Int. Cl. H04L 25/02; H04B 17/391

(52) U.S. Cl. CPC H04L 25/0254; H04B 17/3913

(57) ABSTRACT

Embodiments of this application provide a communication method and related apparatus. The method includes: obtaining a first model, where the first model is used to indicate a physical environment within a predetermined range associated with a central device; and generating a set of reference channels based on a second model and an output of the first model, where the second model is determined based on a position of the central device and the first model.

### CROSS-REFERENCE TO RELATED APPLICATIONS

This application is a continuation of International Application No. PCT/CN2023/117860, filed on Sep. 8, 2023, which claims priority to U.S. Provisional Patent Application No. 63/507,208, filed on Jun. 9, 2023. The disclosures of the aforementioned applications are hereby incorporated by reference in their entireties.

### TECHNICAL FIELD

Embodiments of the present invention relate to the field of communications technologies, and more specifically, to a communication method and related apparatus.

### BACKGROUND

Multiple-input-multiple-output (MIMO) technology has been widely deployed in modern wireless systems to improve system capacity and bandwidth efficiency by making use of space diversities among antenna ports. In order to fully utilize spatial resources and improve wireless throughput, the deployment of multi-user multiple-input-multiple-output (MU-MIMO) has been promoted. MU-MIMO should be paired over the downlink (DL) channels between one base station (BS) and multiple user devices (UEs). It is impracticable for each UE to report its DL channel estimation results to the BS, because the large dimensionality of MU-MIMO channel results in huge signaling overhead needed for DL feedback.

In fourth generation (4G) and fifth generation (5G) systems, it is assumed that a DL channel between one BS and one UE can be approximated by an uplink (UL) channel between the BS and the UE. The UEs send their reference signals to the BS so that the BS can estimate their UL channels respectively, and take UL channel estimations as DL channel estimations. However, radio frequency (RF) and infrared frequency (IF) components (e.g., analog circuits) do not generally hold UL/DL reciprocity assumption. Therefore, the assumption would inevitably damage the overall performance of the communication system.

### SUMMARY

Embodiments of this application provide a communication method and related apparatus. The technical solutions may enable a central device to get a set of reference channels which reflects or indicates the condition of radio channels.

According to a first aspect, an embodiment of the present application provides a communication method, and the method could be performed by a central device. The method includes: obtaining a first model, where the first model is used to indicate a physical environment within a predetermined range associated with a central device; and generating a set of reference channels based on a second model and an output of the first model, where the second model is determined based on a position of the central device and the first model.

In practice, there may be no data about radio channel. According to the above-mentioned technical solution, a set of reference channels could be determined based on the physical environment within a predetermined range associated with the central device. It could enable the central device to get a set of reference channels which reflects or indicates the condition of radio channels.

With reference to the first aspect, in some embodiments, the method could further include: transmitting first information indicating the set of reference channels; and transmitting second information, where the first information could be used to determine one or more reference channels from the set of reference channels.

According to the above-mentioned technical solution, the central device could inform the user device of the set of reference channels, which enables the user device to select one or more appropriate reference channels related to the its DL channel without transmission of channel measurement of the DL channel.

With reference to the first aspect, in some embodiments, the method could further include: receiving third information indicating the one or more reference channels in the set of reference channels, where the one or more reference channels includes a first reference channel; and determining a position of the user device based on the first reference channel and the second model.

In some embodiments, each of the one or more reference channels could be at a distance less than or equal to a predetermined threshold from a DL channel of the user device. For example, the first reference channel could be any one of the one or more reference channels. In another example, the first reference channel may be the reference channel closest to the DL channel among the one or more reference channels. In another example, the central device could determine the position of the user device based on the first reference channel and the second. In addition, more other reference channel(s) among the one or more reference channels could also be used to determine the position of the user device.

According to the above-mentioned technical solution, the second model and the feedback of the user device could be used to estimate or predict the position of the user device. It could reduce the dependence on the sensing or positioning apparatus used to obtain the position of user device.

With reference to the first aspect, in some embodiments, the method could further include: receiving fourth information from a user device, where the fourth information indicates a second reference channel could be used to update the second model.

In practice, the second model may be inaccurate or outdated over time. According to the above-mentioned technical solution, the second model could be updated based on the second reference channel. It enables the central device to determine an appropriate set of reference channels based on the updated second model with more accuracy.

With reference to the first aspect, in some embodiments, the method could further include: transmitting fifth information to the user device based on a first position related to the second reference channel, where the fifth information could indicate user device to transmit the fourth information.

According to the above-mentioned technical solution, the central device could transmit the fifth information based on the first position, which could enhance the representativeness of the second reference channel. Moreover, it could reduce the number of reference channels used to update the second model and reduce signaling overhead.

With reference to the first aspect, in some embodiments, the first position could be determined based on a first graph, where the first graph could indicate a similarity among reference channels in the set of reference channels.

According to the above-mentioned technical solution, the first position could be a position on the first graph, which enables the central device to get the first position without information about the position of the user device. It could reduce dependence on the information about the position of the user device.

With reference to the first aspect, in some embodiments, a distance between the second reference channel and the first position could be less than or equal to a second threshold.

According to the above-mentioned technical solution, when the distance between the second reference channel and the first position is less than or equal to the second threshold, the second reference channel could be used to update the second model. It could reduce the interference of bad data on the update of the second model, and ensure the accuracy of the updated second model.

According to a second aspect, an embodiment of the present application provides a communication method, and the method could be performed by a user device. The method includes: receiving first information from a central device, where the first information indicates a set of reference channels. The set of reference channels is determined based on a second model and an output of the first model. The second model is determined based on a position of the central device and a first model, and the first model is used to indicate a physical environment within a predetermined range around a network device.

With reference to the second aspect, in some embodiments, the method could further include: receiving second information, where the second information could be used to determine the one or more reference channels from the set of reference channels.

With reference to the second aspect, in some embodiments, the method could further include: transmitting third information indicating the one or more reference channels in the set of reference channels.

In some embodiments, the user device could determine one or more reference channels from the first set of reference channels, each of which could be at a distance less than or equal to a first threshold from a DL channel of the user device.

With reference to the second aspect, in some embodiments, a position of the user device could be determined based on a first reference channel and the second model, where the one or more reference channels include the first reference channel.

With reference to the second aspect, in some embodiments, the method could further include: transmitting fourth information indicating a second reference channel, where the second reference channel could be used to update the second model.

With reference to the second aspect, in some embodiments, the method could further include: receiving fifth information based on a first position, where the fifth information could indicate the user device transmitting the fourth information.

With reference to the second aspect, in some embodiments, the first position could be determined based on a first graph, where the first graph could indicate a similarity among reference channels in the set of reference channels.

With reference to the second aspect, in some embodiments, a distance between the second reference channel and the first position is less than or equal to a second threshold.

According to a third aspect, a communication apparatus is provided. The communication apparatus includes a function or unit configured to perform the method according to the first aspect or any one of the possible embodiments of the first aspect.

According to a fourth aspect, a communication apparatus is provided. The communication apparatus includes a function or unit configured to perform the method according to the second aspect or any one of the possible embodiments of the second aspect.

According to a fifth aspect, a system is provided. The system includes: the communication apparatus according to the third aspect and the communication apparatus according to the fourth aspect.

According to a sixth aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform any one of: the method in any one of the first aspect or the possible implementations of the first aspect; the second aspect or the possible implementations of the second aspect.

According to a seventh aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs any one of: the method in any one of the first aspect or the possible implementations of the first aspect; the second aspect or the possible implementations of the second aspect.

According to an eighth aspect, a computer storage medium is provided. The computer storage medium stores program code, and the program code is used to execute one or more instructions for the method according to the first aspect or any one of the possible embodiments of the first aspect, or the second aspect or any one of the possible embodiments of the second aspect.

According to a ninth aspect, this application provides a computer program product including one or more instructions, where when the computer program product runs on a computer, the computer performs the method according to the first aspect or any one of the possible embodiments of the first aspect, or the second aspect or any one of the possible embodiments of the second aspect.

### DESCRIPTION OF THE DRAWINGS

FIG. 1 is a schematic illustration of a communication system.

FIG. 2 illustrates an example communication system.

FIG. 3 illustrates another example of an ED and a base station.

FIG. 4 is an example of a channel model of a MIMO system.

FIG. 5 is a schematic flowchart of a communication method according to an embodiment of the present application.

FIG. 6 is an example of a reference channel used to update a second model.

FIG. 7 is a schematic flowchart of another communication method according to an embodiment of the present application.

FIG. 8 is a schematic diagram of vectorizing a tensor-formed MIMO channel data sample.

FIG. 9 is a schematic diagram of juxtaposing column-wise vectorized channel data samples into a matrix [symbol] .

FIG. 10 is a schematic flowchart of yet another communication method according to an embodiment of the present application.

FIG. 11 is a schematic diagram of an equivalent low-dimensional space represented by a channel space basis.

FIG. 12 is a schematic diagram of approaching a channel space basis by DNN implementation.

FIG. 13 is a schematic diagram of compressing reference channels into low-dimensional space.

FIG. 14 is a schematic flowchart of still yet another communication method according to an embodiment of the present application.

FIG. 15 is a schematic diagram of a pilot pattern.

FIG. 16 is a schematic diagram of transformation of a channel space basis.

FIG. 17 is a schematic flowchart of still yet another communication method according to an embodiment of the present application.

FIG. 18 is a schematic diagram of a scoring function to measure a distance in equivalent low-dimensional space.

FIG. 19 is a schematic diagram of another scoring function to measure a distance in equivalent low-dimensional space.

FIG. 20 is a schematic diagram of a communication method according to an embodiment of the present application.

FIG. 21 is a schematic diagram of another communication method according to an embodiment of the present application.

FIG. 22 is a schematic diagram of yet another communication method according to an embodiment of the present application.

FIG. 23 is a schematic diagram of an example of a selected portion of a set of reference channels.

FIG. 24 is an example of a virtual radio channel generated by a digital twin.

FIG. 25 is an example of an estimation result of a position of user device based on a digital twin.

FIGS. 26-28 are schematic block diagrams of possible devices according to embodiments of this application.

FIG. 29 is a schematic diagram of difference between UL and DL coverage due to Tx powers from BS and UE.

FIG. 30 is a schematic diagram of dimensionality of a terabit multiple-input-multiple-output (T-MIMO) channel.

FIG. 31 is a schematic diagram of prior knowledge corresponding to environment and sub-environments.

FIG. 32 illustrates units or modules in a device.

### DETAILED DESCRIPTION OF THE ILLUSTRATIVE EMBODIMENTS

Unless otherwise stated or implicated from context the following terms and phrases have the meanings provided below.

### (1) Central Device and User Device

A wireless system may include a central device and a number of user devices. The central device can be a BS, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distribute unit (DU), a positioning node, or an apparatus (e.g., a communication module, a modem, or a chip) in the forgoing devices, among other possibilities; and the user device may include such devices (or may be referred to) as a user equipment (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or an apparatus (e.g., a communication module, a modem, or a chip) in the forgoing devices, among other possibilities. In the wireless system, a user device is connected to a central device in a wireless way of including a downlink (DL) where the central device transmits signals to the user device and an UL where the user device transmits signals to the central device. Both the DL and the UL transmit signals over radio channels.

### (2) Radio Channel

A radio channel may result from a multi-path fading channel, which is affected by its surroundings to varying degrees. Radio rays or clusters (or groups) of rays of the radio channel may be subjected to reflections and diffraction of radio wave or electromagnetic waves on surrounding physical surfaces, edges, or corners of buildings, roads, buses, tracks, persons, and so on, which may result in a plurality of radio paths at the receiving apparatus side. Some surfaces, edges, and corners are immobile (e.g., buildings, bridges, poles, roads, pavements), whereas others are moving (e.g., moving vehicles), which may result in a timing variation (fading) on a plurality of radio paths. Most moving entities in practice may follow certain trajectories with certain velocities (e.g., vehicles driving on the road), which may be also regulated by a surrounding environment consisting of some immobile entities. Therefore, a radio channel may be closely related to the surrounding environment where it is located.

### (3) Environment Parameter Set

An environment parameter set may be a generalized definition that includes but is not limited to at least one of the following: a spatial area, a frequency band, a duplex mode (e.g., time division duplex or frequency division duplex; half duplex or full duplex), a time or time duration, a precoder, weather, and data traffic (e.g. traffic mode or non-traffic mode. The traffic mode refers to periods during which data traffic exceeds a certain threshold. The non-traffic mode refers to periods during which data traffic is below or equal to the certain threshold.) In some implementations, the spatial area may indicate an area related to a spatial domain.

The difference between two environment parameter sets may be caused by at least one of the spatial area, the frequency band, the duplexing mode, the time or time duration, or the precoder. An environment parameter set can represent a channel condition or a radio environment, and changes in environment parameter sets will lead to changes in the channel conditions or radio environments. A device related to an environment parameter set or an environment parameter set related to a device can be interpreted as the device is located in or will be located in a certain radio environment; or the device can transmit and receive information under a certain channel condition corresponding to an environment parameter set.

### (4) Channel Data Sample

A channel data sample may be measured and/or accumulated by user devices and/or a central device located in a certain radio environment represented by an environment parameter set. A set of channel data samples may contain a plurality of radio channel data samples, which may include one or more of channel states, channel measurements, channel coefficients, and so on. The set of channel data samples may also be known as a data sample set or a learning data set or a training data set. A channel data sample may be in the form of a matrix or a tensor and may apply a fixed vectorization order to all the channel data samples, and save or remember the vectorization order.

### (5) Reference Channel

Reference channels can be used to indicate possible radio channels existing in a certain radio environment where a central device and a plurality of user devices are located, where the certain radio environment can be represented by an environment parameter set. A reference channel may be a virtual radio channel related to a certain environment parameter set; or a reference channel may be a channel data sample selected from channel data samples. The reference channel may also be known as an anchor channel or a mooring channel.

A reference channel may be regarded as data or information of a channel that may exist between a central device and a user device. The reference channel is not a channel used to transmit information.

### (6) Distance Between Two Channels

A distance between two channels can be interpreted as the similarity or correlation between two channels in the present application. The two channels may include two reference channels, or the two channels may include a DL channel and a reference channel.

### (7) Common Information Related to an Environment Parameter Set

A plurality of radio channels may share a same channel condition or a same radio environment, therefore the plurality of radio channels would share some commonality related to a same environment parameter set. The commonality may be regarded as common information about the radio channels related to the environment parameter set. The common information may also be known as environment prior-knowledge of radio channels related to the environment parameter set.

The common information of a number of radio channels between a central device and a plurality of user devices related to an environment parameter set may be learned or acquired. The common information related to the environment parameter set may be validated, persistent, and useful for a radio channel. The radio channel is between the central device and a user device that enters into a radio environment, and the radio environment is represented by the environment parameter set for a period of time after the common information is acquired. Therefore, the common information may represent spatial and timing-persistent commonality, which is relevant to said environment parameter set.

The common information related to an environment parameter set can be determined by a plurality of channel data samples measured and/or accumulated in a radio environment represented by the environment parameter set.

A central device may have a plurality of common information, each of which is related to one environment parameter set. For example, these environment parameter sets may be either overlapping or non-overlapping in a spatial area; or these environment parameter sets may be either overlapping or non-overlapping between the UL and the DL; or these environment parameter sets may be either overlapping or non-overlapping across radio bands.

Common information can be used for compressing a reference channel or a channel measurement. The common information can also be used for a user device to determine information of a DL channel. The information of a DL channel includes information indicating one or more reference channels with sufficient similarity to the DL channel.

### (8) User Device Pairing

User device pairing is a procedure of selecting at least two user devices for transmitting in spatial multiplexing mode on a same radio time-frequency resource. The user device pairing may also be known as user device grouping.

Technical terms, such as “reference channel”, “environment parameter set”, “channel data sample”, “distance”, “common information”, and “user device paring” are not limited to the specific example names presented herein; these terms or the concepts referred to by these terms may also be known by other names.

The following describes the technical solutions in this application with reference to the accompanying drawings.

The technical solutions in embodiments of this application may be applied to various communication systems, such as a Global System for Mobile Communication (GSM) system, a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunication System (UMTS), a Worldwide Interoperability for Microwave Access (WiMAX) communication system, a wireless local area network (WLAN), a fifth generation (5G) wireless communication system, a new ratio (NR) wireless communication system, a sixth generation (6G) wireless communication system, or other evolving communication systems.

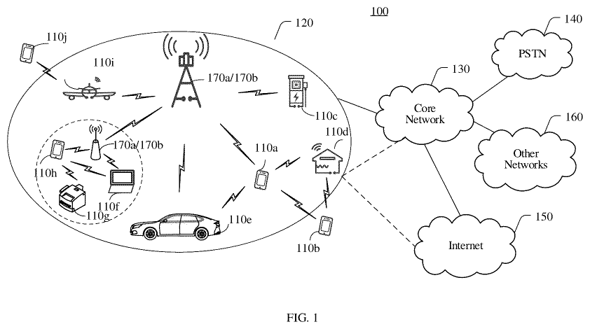

For ease of understanding the embodiments of this application, a communication system shown in FIGS. 1-3 is firstly used as an example to describe in detail a communication system to which the embodiments of this application are applicable.

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 includes a public switched telephone network (PSTN) 140, the internet 150, and other networks 160.

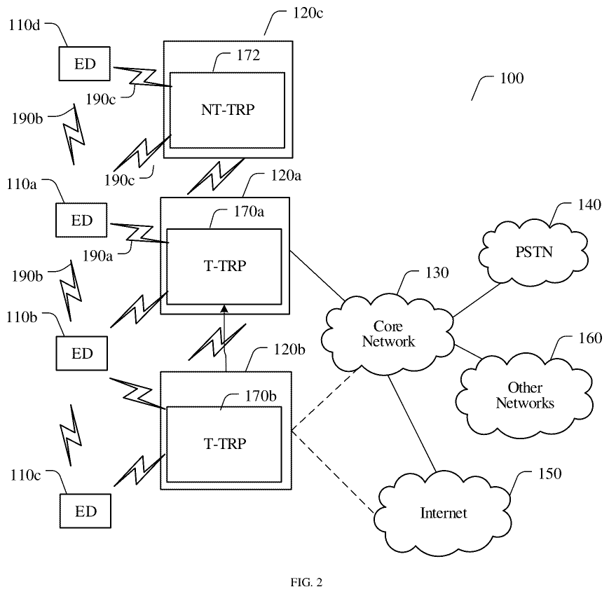

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

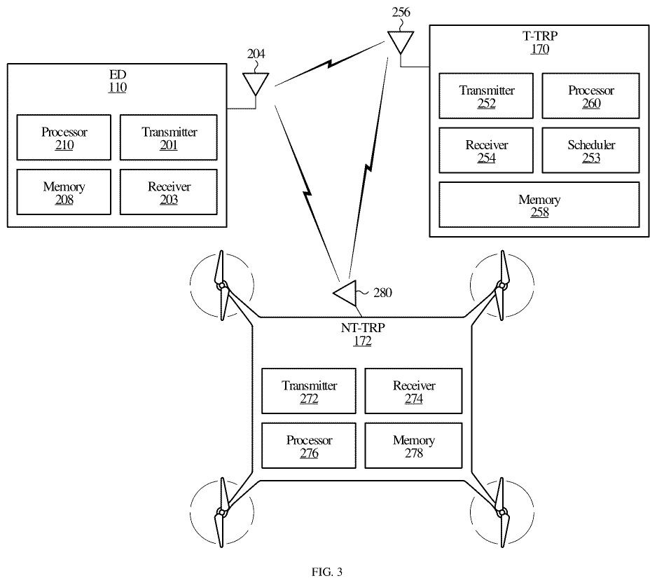

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a UE, a WTRU, a mobile station, a fixed or mobile subscriber unit, a cellular telephone, a STA, a MTC device, a PDA, a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communication.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, BBU, RRU, radio unit (RU), AAU, RRH, CU, DU, positioning node, among other possibilities. The T-TRP 170 may be macro BSs, pico BSs, relay node, donor node, or the like, or combinations thereof. The T-TRP 170 may refer to the forging devices or apparatus (e.g., communication module, modem, or chip) in the forgoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

MIMO technology allows an antenna array of multiple antennas to perform signal transmissions and receptions to meet high transmission rate requirements. The above ED 110 and T-TRP 170, and/or NT-TRP use MIMO to communicate over the wireless resource blocks. MIMO utilizes multiple antennas at the transmitting apparatus and/or receiving apparatus to transmit parallel wireless signals over the wireless resource blocks. MIMO may beamform parallel wireless signals for reliable multipath transmission over a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained greater attention from academia and industry. In the large-scale MIMO system, the T-TRP 170 and/or NT-TRP 172 are generally configured with more than ten antenna units (such as 128 or 256), and serve dozens of the ED 110 (such as 40). A large number of antenna units of the T-TRP 170 and/or NT-TRP 172 can greatly increase the degree of spatial freedom of wireless communication, greatly improve the transmission rate, spectrum efficiency and power efficiency, and eliminate the interference between cells to a large extent. The increased number of antennas allows each antenna unit to be smaller in size with a lower cost. Using the degree of spatial freedom provided by the large-scale antenna units, the T-TRP 170 and/or NT-TRP 172 of each cell can communicate with many ED 110 in the cell on the same time-frequency resource, thus greatly increasing the spectrum efficiency. A large number of antenna units of the T-TRP 170 and/or NT-TRP 172 also enable each user to have better spatial directivity for uplink and downlink transmission. Therefore, the transmission power of the T-TRP 170 and/or NT-TRP 172 and an ED 110 is reduced, and the power efficiency is increased. When the antenna number of the T-TRP 170 and/or NT-TRP 172 is sufficiently large, random channels between each ED 110 and the T-TRP 170 and/or NT-TRP 172 can approach orthogonality. The interference between the cell and the users and the effect of noise can be eliminated. The plurality of advantages described above enable large-scale MIMO systems to have good prospects for application.

A MIMO system may include a receiving apparatus connected to a receive (Rx) antenna, a transmitting apparatus connected to transmit (Tx) antenna, and a signal processor connected to the transmitting apparatus and the receiving apparatus. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

In the present application, a central device may be network nodes 170a or 170b in FIG. 1, and a user device may be one of EDs 110a-110j in FIG. 1; or a central device may be one of T-TRP 170a-170b and NT-TRP 172 in FIG. 2, and a user device may be one of EDs 110a-110d in FIG. 2; or a central device may be T-TRP 170 or NT-TRP 172 in FIG. 3, and a user device may be ED 110 in FIG. 3.

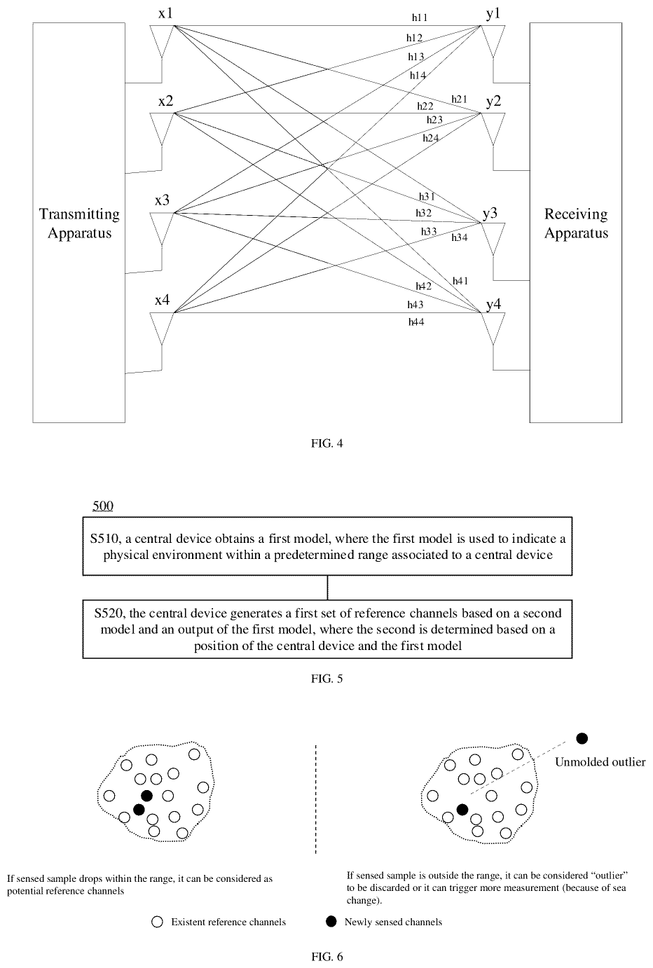

FIG. 4 is an example of a channel model of a MIMO system. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, a reference signal sent by a transmitting apparatus may be used to track a change in the time domain and/or frequency domain of a channel, so as to reconstruct or restore a received signal. The reference signal may also be referred to as a pilot signal, a reference sequence or the like, and is described as a reference signal in the following for ease of understanding. The reference signal includes, for example, a channel state information-reference signal (CSI-RS), a sounding reference signal (SRS), a demodulation reference signal (DMRS), phase track reference signals (PT-RS), or cell reference signals (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e., a user device) may perform channel estimation on each physical antenna port based on a CSI-RS sent by a transmitting apparatus (i.e., a central device), to feedback channel state information (CSI) based on a channel estimation result. The CSI may include related information such as a channel quality indicator (CQI), a precoding matrix indicator (PMI), a layer indicator (LI), and a rank indicator (RI). The CSI is used to reconstruct or precode the downlink channel. In some embodiments, a process in which the central device obtains CSI may include: sending, by the central device, a reference signal to the UE; obtaining, by the UE, an estimated CSI value according to the received reference signal; selecting, by the UE, a precoding vector from a codebook according to the estimated CSI value and feedback related to the index of the precoding vector to the central device; and determining, by the central device, a CSI reconstruction value with reference to the index of the precoding vector. The CSI reconstruction value can be a CSI closest to the true value of the CSI that can be obtained by the central device.

In an embodiment, a transmitting apparatus maps a sequence of reference signals to certain physical resources, and transmits the reference signals over the certain physical resources. The sequence of reference signals and the physical resources are known to both the transmitting apparatus and the receiving apparatus receiving the reference signals. Therefore, the receiving apparatus could perform channel estimation based on the known sequence of reference signals and the received signals.

A transmitting apparatus may map a sequence to physical resources to transmit reference signals. The physical resources may include multiple resource elements, where the resource elements are the physical resources allocated for transmission of the reference signals. For example, the resource elements are with the common resource blocks allocated for physical downlink shared channel (PDSCH) transmission when DM-RSs are transmitted.

Positions of physical resources of reference signals may be referred to as reference signal patterns or pilot patterns. The positions of the physical resources are generally described through at least one of the following dimensions: time dimension, frequency dimension, or spatial dimension.

The time dimension could be represented by one or more time domain resource units. A time domain resource unit may include, but is not limited to, a symbol, an orthogonal frequency division multiplexing (OFDM) symbol, and a slot. In some embodiments, the time domain unit may be represented by a symbol index, an OFDM symbol index, or a slot index.

The frequency dimension could be represented by one or more frequency domain resource units. A frequency domain resource unit may include, but is not limited to, a subcarrier or a subband. In some embodiments, the frequency domain unit may be represented by a subcarrier index or a subband index. In some embodiments, the frequency domain unit may also be represented by a resource element (RE) index, a resource block (RB) index, or a resource block group (RBG) index. An RE includes a symbol in a time domain and a subcarrier in a frequency domain, and an RE index could be used to indicate a position of a subcarrier. An RB includes a slot in the time domain and 12 consecutive subcarriers in the frequency domain. An RB index could be used to indicate positions of 12 subcarriers. An RBG consists of a group of RBs, and an RBG index could be used to indicate positions of a group of subcarriers.

The spatial dimension could be represented by one or more spatial domain resource units. A spatial domain resource unit may be represented by an antenna port. In the embodiments of this application, an antenna port may be a Tx antenna. The antenna port may be identified by an antenna port index.

To facilitate understanding of the embodiments of this application, in the following exemplary description, a symbol index is used to represent a position of a time domain resource unit, a subcarrier index is used to represent a position of a frequency domain resource unit, and an antenna port index is used to represent a position of a spatial domain resource unit.

A process of channel estimation described above is merely an example for description, and shall not constitute any limitation on this application. Processes of channel estimation are known in conventional technology and, for brevity, detailed descriptions of the specific processes are omitted herein.

The receiving apparatus could be an ED (i.e., a user device) and the transmitting apparatus could be a T-TRP or NT-TRP (i.e., a central device), or the receiving apparatus could be a T-TRP or NT-TRP (i.e., a central device) and the transmitting apparatus could be an ED (i.e., a user device). In some embodiments, the transmitting apparatus could be a central device and the receiving apparatus could be a user device when the reference signals in these embodiments are downlink (e.g., CSI-RS). The transmitting apparatus could be a user device and the receiving apparatus could be a central device when the reference signals in these embodiments are uplink (e.g., SRS). While one transmitting apparatus could transmit reference signals to one or more receiving apparatus, the following embodiments focus on the methods between one transmitting apparatus and one receiving apparatus for the sake of simplicity; these examples are not intended to limit the scope of the application.

As mentioned above, channel data samples may be measured and/or accumulated by user devices and/or a central device located in a certain radio environment represented by an environment parameter set. The channel data samples could be used to determine common information related to the environment parameter set, and a set of reference channels could be selected from the channel data sample. It enables a wireless communication system to determine information relating to a DL channel of user device without transmitting a channel measurement of the DL channel of the user device. Therefore, signaling overhead for transmission of DL channel measurements is reduced. However, in some scenarios, for an environment parameter set, there may be no channel data sample that is measured and/or accumulated. The lack of channel data samples would result in a lack of common information and the set of reference channel related to the environment parameter set. In other scenarios, there may be some channel data samples, but the number of channel data samples may be not enough to get the set of reference channels and/or the common information related to the environment parameter set.

With the problem identified above, it is to be solved that how to generate a set of reference channels in the scenario mentioned above. In present application, a central device obtains a first model indicating a physical environment within a predetermined range associated with the central device, and generates a set of reference channels based on the first model and a second model, where the second model is determined based on a position of the central device and the first model. Therefore, the central device could obtain reference channels without data about radio channels. In the following, the communication method provided in this application will be described in combination with FIG. 5.

FIG. 5 illustrates a flowchart of a method 500 for communicating. The method may be applied to single-user multiple-input-multiple-output (SU-MIMO). The method may also be applied to MU-MIMO. The method 500 shown in FIG. 5 includes steps S510 and S520. The following separately describes the steps in detail.

At S510, the central device obtains a first model, where the first model is used to indicate a physical environment within a predetermined range associated with the central device.

The “first model” is only named for differentiation and does not limit the scope of protection of the embodiments of this application. Similarly, a “second model”, a “first reference channel”, a “first graph”, a “second reference channel”, etc. in the following description are also only named for differentiation and do not limit the scope of protection of the embodiments of this application, and this will not be repeated below.

In possible implementations, the predetermined range associated with the central device could be an arbitrary range related to the central device. The predetermined range could be preset or obtained from other device.

In one embodiment, the predetermined range associated with the central device could include all or part of a coverage area for transmission of the central device.

In another embodiment, the central device may be related to at least one environment parameter set, which includes a first environment parameter set. In one example, the predetermined range associated with the central device could be a spatial area related to the first environment parameter set. In another example, the predetermined range associated with the central device could be a portion of the spatial area related to the first environment parameter set.

Moreover, in the predetermined range associated with the central device, there may be objects such as buildings, bridges, roads, pavements, lakes, walls and so on. These objects could form the physical environment within the predetermined range associated with the central device. The first model could indicate at least one of a position, a dimension, and a surface material of objects located in the predetermined range. The “physical environment” may be an environment that actually exists.

In possible implementations, the first model may include a map. The map could illustrate specific and/or detailed features of a given area or region. For example, the map could illustrate a position, a dimension, and/or a surface material of objects within the given area.

The map may be in various forms. For example, the first model could include a dimensional, static, dynamic, or interactive map.

In one embodiment, the first model could include a three-dimensional (3D) map. The 3D map may include detailed dimensions and/or surface materials of the central device's surroundings such as buildings, pavements and so on.

At S520, the central device generates a set of reference channels based on a second model and an output of the first model, and the second model is determined based on a position of the central device and the first model.

In possible implementations, the second model could include a digital twin, which is a virtual model designed to reflect radio channels existing in a given radio environment. For example, the digital twin could be used to generate a virtual radio channel.

In practice, a radio channel may be closely related to the surrounding environment where it is located. Radio rays or clusters (or groups) of rays of the radio channel may be subjected to reflections and diffusions of radio electric magnetic waves on surrounding physical surfaces, edges, or corners of buildings, roads, buses, tracks, persons, and so on, which may result in a plurality of radio paths at the receiver side.

In possible implementations, the digital twin could be based on a ray tracing method. That is to say, it could generate a virtual radio channel by tracing a path of virtual ray from the central device. As it traverses the scene, the virtual ray may be reflected from an object to another object (causing reflections), be blocked by objects (causing shadows), or pass through transparent or semi-transparent objects (causing refractions). All of these interactions could be combined to determine a virtual radio channel.

In some embodiments, a digital twin could be determined based on the position of the central device and the first model indicating the physical environment within a predetermined range. Rays, group of rays, and/or clusters of rays, in a predetermined range associated with the central device, could be generated based on the digital twin and the first model. It would result in virtual radio channels related to the predetermined range.

In possible implementations, a plurality of virtual radio channels related to the predetermined range associated with the central device could be generated based on the digital twin. The set of reference channels could be generated based on the plurality of virtual radio channels.

In some embodiments, a predetermined range related to the central device could be considered as a spatial area related to an environment parameter set (e.g., a first environment parameter set). For example, there may be no channel data sample that is measured and accumulated by user devices and/or the central device related to the environment parameter set. The central device may not be able to obtain a set of reference channels without channel data samples. Moreover, since information related to the environment parameter set is determined based on channel data samples related to the environment parameter set, a lack of channel data samples may also result in a lack of information related to the environment parameter set, such as common information related to the environment parameter set. In this scenario, virtual radio channels could be used as channel data samples to generate a set of reference channels. In a detailed design, a plurality of virtual radio channels could be used as channel data samples, and could form a set of channel data samples (e.g., including M channel data samples) related to the environment parameter set. The set of channel data samples could be used to determine common information related to the environment parameter set. A set of reference channels including K reference channels, could be selected from the M channel data samples, where M and K are positive integers, and K≤M. Therefore, the set of reference channels related to the environment parameter set could be generated.

In another example, there may be some channel data samples that are measured and/or accumulated, but the number of channel data samples may be not enough to determine information and/or a set of reference channels related to the environment parameter set. In this scenario, the virtual radio channels could be used as channel data samples, and could be used to determine a set of channel data samples related to the environment parameter set. Therefore, a set of reference channels could be generated.

In possible implementations, the K reference channels can be determined by any one of: randomly selecting K channel data samples from the M channel data samples as K reference channels; selecting the most representative K channel data samples from the M channel data samples by K-means, Gaussian Mixture Models (GMM), or other classification algorithms; or selecting the most representative K channel data samples from the M channel data samples based on the distances among the channel data samples.

In some possible implementations, the set of reference channels includes multiple compressed reference channels. The multiple compressed reference channels could be determined by compressing multiple reference channels based on a compression function, where the multiple reference channels are determined based on the plurality of channel data samples.

The multiple reference channels include a portion or all of the K reference channels. The compression function could be determined based on the environment parameter set. For example, the compression function is related to the common information of the environment parameter set. In a detailed design, the compression function is related to common information determined based on the M channel data samples of the environment parameter set. In other words, the multiple compressed reference channels are determined by the common information.

In some other implementation, the compression function is determined by down-sampling a pre-compression function based on a pilot pattern, where the pre-compression function is determined based on the environment parameter set.

The pilot pattern includes any one of: a uniform pilot pattern, a dense pilot pattern, or a non-uniform and sparse pilot pattern. The pilot pattern may also be known as any one of: a pilot placement, a pilot position pattern, or a reference signal placement pattern, or a reference signal position pattern.

In some possible implementations, the pilot pattern may be pre-negotiated between the central device and the user device.

In one embodiment, the most representative K channel data samples could be determined based on a similarity among the M channel data samples. For example, the central device scores the distances among M channel data samples by a scoring (or measuring) function based on the common information related to the environment parameter set. The central device could turn the M channel data samples into a graph based on the distances among M channel data samples. Then the central device may select the K most-degreed data samples and a set of reference channels could be determined. The degree is a graph theory term that indicates how many connections a node on a graph has. A node with a higher degree is known as a hub node on a graph. A node with a higher degree means it is more typical or representative. Since the set of reference channels is selected from the M channel data samples, the graph could indicate a similarity among a plurality of reference channels in the set of reference channels. The graph related to the environment parameter set could be referred to a first graph.

In another example, a similarity among different channels could be determined based on the likelihood among them. For example, the probability density function could be deployed to determine the likelihood between two channels.

The scoring (or measuring) function may include but is not limited to the following: a Euclidean function; an inner product between two vectors; a heat Kernel function when a channel can be represented by a vector.

In some scenarios, the “most representative K channel data samples” means that the channel data sample can be used as a reference channel used for pairing of at least two user devices. In other scenarios, the spatial projection channel of the “most representative K channel data samples” can be used for pairing of at least two user devices.

In possible implementations, the central device could transmit first information indicating the set of reference channels. And correspondingly, a user device could receive the first information and determine one or more reference channels from the set of reference channels.

In some embodiments, each of the one or more reference channels could be at a distance less than or equal to a first threshold from a DL channel of the user device.

The DL channel is a radio channel used to receive information from the central device. A distance between the DL channel and a reference channel represents the similarity or correlation between the DL channel and the reference channel. The first threshold is a distance threshold used to select one or more reference channels with sufficient similarity to the DL channel. When a reference channel has sufficient similarity to the DL channel, the reference channel can be used to represent the DL channel. In a detailed design, the one or more reference channels include one or more of: the closest reference channel to the DL channel, the second closest reference channel to the DL channel, and/or the third closest reference channel to the DL channel, etc. In some scenarios, the closest reference channel, the second closest reference channel and so on may help the central device to determine information relating to the DL channel of user device without transmitting a channel measurement of the DL channel of the user device.

In possible implementations, the central device could transmit second information that is used to determine one or more reference channels from the set of reference channels. And correspondingly, the user device could receive the second information.

For example, the central device could transmit the first information firstly, and then transmit the second information. In another example, the central device could transmit the second information and then transmit the first information. In another example, the central device could transmit the first information and the second information in the same time unit (i.e. time interval/slot) and/or in the same message.

In possible implementations, the second information could include one or more of: a first pilot pattern, a first compression function, a first scoring function, and the first threshold. For example, the predetermined range associated with the central device could be all or a portion of a spatial area related to the first environment parameter set. The first pilot pattern could be a pilot pattern related to the first environment parameter set mentioned above. Similarity, the first compression function and the first scoring function could be a compression function and a scoring function related to the first environment parameter set, respectively.

In one embodiment, the set of reference channels may include a compressed reference channel, which is determined by compressing a reference channel based on the first compression function. The user device could use the first compression function and the compressed reference channel in the set of reference channels to determine the reference channel before compression.

In another embodiment, the user device could use the first scoring function to determine a distance between the DL channel and a reference channel in the set of reference channels. Moreover, the one or more reference channels at a distance less than or equal to the first threshold from the DL channel of the user device, could be determined from the set of reference channels based on the first scoring function.

In possible implementations, the user device could transmit third information indicating the one or more reference channels. And correspondingly, the central device could receive the third information.

In one embodiment, there may be only one reference channel in the set of reference channels, which is at a distance less than or equal to the first threshold from the DL channel of the user device.

In some embodiment, there may be a plurality of reference channels in the set of reference channels, each of which is at a distance less than or equal to a first threshold from the DL channel. For example, the user device may determine all reference channels in the set of reference channels, which has a distance less than or equal to the first threshold from the DL channel, and report all these reference channels to the central device. In order to reduce signaling overhead, the user device could report a part of these reference channels. For example, the user device could report one or more of these reference channels, such as the top F closest reference channels to the DL channel, F reference channels randomly selected from these reference channels, and so on. F is a positive integer. Moreover, the central device may receive information related to the reference channel(s) reported by the user device. For example, the information may indicate which reference channel is the closest reference channel to the DL channel, the second closest reference channel to the DL channel, and/or the third closest reference channel to the DL channel, etc. In another example, the information may indicate a distance between the DL channel and each reference channel reported by the user device, and the central device could determine the reference channel closest to the DL channel among the reference channel(s) reported by the user device.

Therefore, based on reference channel(s) reported by the user device, the central device can determine information related to the DL channel without transmission of a channel measurement of the DL channel, which can reduce signaling overhead for transmission of DL channel measurements.

In some embodiments, the one or more reference channels may include a first reference channel. For example, the first reference channel could be any one of the one or more reference channels. In another example, the first reference channel may be the closest reference channel to the DL channel. In another example, the user device could only determine the closest reference channel to the DL channel and report it to the central device.

In possible implementations, the central device could determine a position of the user device based on the first reference channel and the second model. For example, the first reference channel could be mapped back to the digital twin. Therefore, a position of the user device on a map of the predetermined range associated with the central device could be estimated. In another example, in order to obtain a more accurate position of the user device, other reference channel(s) among the reference channels reported by the user device may also be mapped to the digital twin.

Moreover, when the user device is moving, reference channels reported by the user device at different time units (i.e. time interval/slot) may be different. Based on the digital twin and the different reference channels reported by the user device, the central device could determine the trajectory of the user device. The central device could further estimate or predict the position of the user device.

In some embodiments, since a node, a vertice, or a reference channel could be related to a position on the first graph, a position on the first graph could be determined based on reference channel(s) reported by the user device. And the position on the first graph could be used to represent the position of the user device.

In possible implementations, the central device could receive fourth information indicating a second reference channel, which is used to update the second model. Correspondingly, a user device could transmit the fourth information.

In one embodiment, the second reference channel may be provided by feedback from a physical reference user device. Some physical reference user devices (which may also be called anchor user devices or sensing user devices) may be deployed on some critical positions in the targeted radio environment, and then may provide feedback on their DL channels to the central device. For example, these physical reference user devices may be deployed on some critical positions within the predetermined range, where their feedbacks could be taken as examples of the second reference channel and be used to update the digital twin. In another example, these physical reference user devices may be deployed on some random positions within the predetermined range.

In another embodiment, some user devices could be located within the predetermined range. For example, the central device could use uplink sounding reference signals (UL-SRS) sounding channels to tune or update the digital twin. In another example, a user device could estimate its DL channel and then may provide feedback on CSI-RS to the central device, and the central device could use the feedback to tune or update the digital twin.

In possible implementations, the central device could transmit fifth information based on a first position related to the second reference channel, where the fifth information indicates the user device to transmit the first information.

In one embodiment, when the physical reference user devices are deployed on random positions within the predetermined range, the central device may select one or more critical positions from these random positions based on the first model. For example, a critical position could include but not be limited to: a position on crossroads, a corner of pavements, and so on. The central device could transmit the fifth information to one or more physical reference user devices located on or around the critical position. The physical reference user device could provide feedback on its DL channel. The critical position could be taken as an example of the first position.

In some embodiments, the first position could be determined based on a first graph.

In one embodiment, one or more critical nodes, or vertices, or reference channels (e.g., D nodes) could be determined based on the first graph. Herein, D is a positive integer. In one example, the central device could select the D most-degreed nodes from nodes that the first graph has. Any one among the D most-degreed nodes may represent a critical position, which could be taken as an example of the first position. In another example, radio channels could be accumulated around these critical positions, which could be used as reference channels to update the digital twin. In another example, the central could transmit information to instruct physical reference user devices to accumulate radio channels around these critical positions.

In practice, the central device may obtain a reference channel that may not be appropriate to update the digital twin. In other words, for an update of the digital twin, the reference channel may be bad data. For example, when a distance between the reference channel and the first position is too far, the reference channel could be considered as bad data. In order to reduce the negative impact of bad data on the update of the digital twin, the central device could determine whether the reference channel could be used to update the digital twin.

In some embodiments, the central device could determine whether the second reference channel could be used to update the digital twin. In one example, the central device could discard the second reference channel when a distance between the second reference channel and the first position is larger than the second threshold. In another example, the central device could update the digital twin based on the second reference channel when the distance between the second reference channel and the first position is less than or equal to the second threshold. Moreover, after the update of the digital twin, virtual radio channels generated by the digital twin could be corrected, and a distance between the second channel and a corrected virtual radio channel generated by the updated digital twin could be less than or equal to a predetermined threshold.

In one embodiment, the distance between the second reference channel and the first position could be determined based on the first graph. For example, the first position could be related to a critical position on the first graph, and the second reference channel could be mapped to a position on the first graph, where a distance between the two positions could represent the distance between the second reference channel and the first position.

In another embodiment, the central device could evaluate the second reference channel based on the channel data samples generated by the digital twin. In one example, channel data samples could be divided into one or more clusters based on the critical positions. When the central device obtains a new reference channel used to tune the digital twin, the central device could determine the similarity between the new reference channel and possible or candidate clusters.

As shown in FIG. 6, the newly sensed channel could be taken as an example of the second reference channel. The range within the dashed line in FIG. 6 could represent “range” mentioned in FIG. 6, which could be taken as an example of a range where the distance from the first position is equal to the second threshold. When the newly sensed channel is located in the range, it could be considered that a distance between the newly sensed channel and the first position is less than the second threshold. As shown in FIG. 6, when a newly sensed channel drops within the range, it could be used to tune the digital twin. When a newly sensed channel is outside the range, it might be considered as “outlier”. The central device could discard the “outlier” or it may trigger more measurements.

In the present application, the central device could transmit information indicating a first set of reference channels to a user device to obtain a reference channel with sufficient similarity to a DL channel of the user device. Therefore, the central device can determine information related to the DL channel without transmission of a channel measurement of the DL channel, which can solve the problem of high signaling overhead for transmission of channel measurements.

FIG. 7 shows a schematic flowchart of a method 600 according to an embodiment of the present application. The method 600 shown in FIG. 7 illustrates how a central device obtains a reference channel in the first set of reference channels mentioned in S520 of the method 500. The method 600 can be executed before S520. The method includes steps S601 and S602.

At S601, a central device vectorizes M channel data samples related to the first environment parameter set.

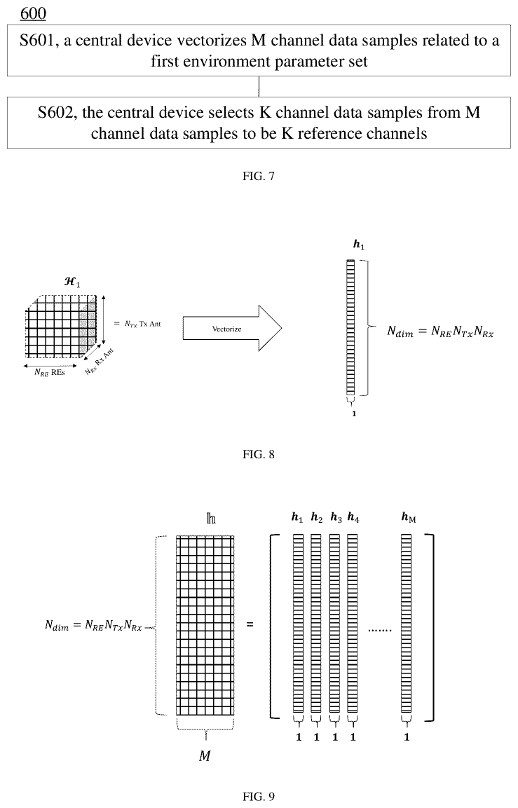

FIG. 8 shows an example to vectorize a three-dimensional tensor into a vector. In FIG. 8, a channel data sample is represented as a three-dimensional tensor [symbol] ₁ represented by N_{RE}-by-N_{Rx}-by-N_{Tx}, where N_{RE}-by-N_{Rx}-by-N_{Tx} represents the size of the three-dimensional tensor [symbol] ₁. Specifically, N_{RE}-by-N_{Rx}-by-N_{Tx} represents that the three-dimensional tensor [symbol] ₁ includes N_{RE} matrices (or two-dimensional tensors), each of which has N_{Rx} rows and N_{Tx} columns. N_{RE} represents the number of RES, N_{Tx} represents the number of transmit (Tx) antenna ports, and N_{Rx} represents the number of receive (Rx) antenna ports. [symbol] ₁ is vectorized into a column vector h₁ (represented by N_{dim}-by-1, N_{dim}=N_{RE}N_{Tx}N_{Rx}) in a vectorization order of RE, then Tx, then Rx. The following disclosure uses “RE→Tx→Rx” to represent the above vectorization order. N_{dim}-by-1 represents vector h₁ having N_{dim} rows and 1 column, which is a product of N_{RE}, N_{Rx} and N_{Tx}.

When a first channel data sample is represented as a tensor [symbol] ₁ (represented by N_{RE}-by-N_{Rx}-by-N_{Tx}), the device may vectorize it in RE→Tx→Rx order into h₁, a first column-wise vector. When a second channel data sample is represented as a tensor [symbol] ₂ (represented by N_{RE}-by-N_{Rx}-by-N_{Tx}), the device may vectorize it in the same order into h₂ (represented by N_{dim}-by-1, N_{dim}=N_{RE}N_{Tx}N_{Rx}), a second column-wise vector. Similarly, the device could vectorizes all channel data samples in tensor into column-wise vectors. Then, the central device may juxtapose all the column-wise vectorized channel data samples into a matrix. Juxtaposing or juxtaposition is a process of placing column-wise vectors in a column-by-column arrangement, or placing row-wise vectors in a row-by-row arrangement, to obtain a matrix.

In one example, a sufficient number (e.g., M) of the vectorized channel data samples are placed into a N_{dim}-by-M matrix: [symbol] =[h₁ h₂ . . . h_{M}] in FIG. 8, where N_{dim}>>M>rₑₙᵥ, N_{dim}-by-M represents matrix [symbol] is with N_{dim} rows and M columns, and rₑₙᵥ is the rank of the environment parameter set, which is related to how complicated the common information is. In mathematics, rₑₙᵥ is the number of principal components of the common information.

It should also be noted that in the deduction above we set h as a column-wise vector. Without loss generality, if h is set as a row-wise vector, then a sufficient number (e.g., M) of the vectorized channel data samples can be placed into a M-by-N_{dim} matrix:

$$= [ \begin{matrix}{h}_{1} \\ ⋮ \\ {h}_{M}\end{matrix} ] ,$$

where M-by-N_{dim} represents matrix [symbol] has M rows and N_{dim} columns. Mathematically, both the row-wise vector and the column-wise vector are equivalent. In the following discussion, we will use the column-wise vector version.

In some implementations, S601 may also be executed by a remote data center or a powerful user device.

In some implementations, channel data samples may be accumulated and prepared in the following ways, which include but are not limited to:
1) The channel data samples may be measured and then accumulated by either central device or user devices or both during historical communication processes. For example, a central device may use uplink sounding reference signal (UL-SRS) sounding channels to accumulate the channel data samples. User devices may estimate the DL channel and then may provide feedback on CSI-RS to the central device. The central device accumulates feedback on CSI-RS as the channel data samples.
2) The channel data samples may be provided by feedback from some physical reference user devices. These physical reference user devices (which may also be called anchor user devices or sensing user devices) may be deployed on some critical positions in the targeted radio environment. These physical reference user devices may also be deployed on some random positions in the targeted radio environment. The physical reference user devices may receive DL signals from the central device and estimate DL channels. After estimating the DL channels, the physical reference user devices may provide feedback on their DL channels to the central device who accumulates them as channel data samples. For example, the physical reference user devices may provide feedback on their DL channels in a compressed format.
3) The channel data samples may be virtually generated by a digital environment simulator. The digital environment simulator may be called a digital twin of the targeted radio environment.

In practice, the channel data samples may be accumulated by combining the above alternative approaches in a dynamic manner. For example, at the first stage in which there is no channel data sample at all, the first common information is based on the channel data samples accumulated and prepared in the third approach. Then the first common information of the first stage may use the first approach and/or the second approach to accumulate and prepare channel data samples acquired during the second stage. The second common information may be refined by the channel data samples accumulated during the second stage. In addition, physical reference user devices of the second approach may detect some significant changes in the targeted radio environment. The significant changes in the targeted radio environment may trigger the third round of refining the third common information. The central device may decide which stage the system enters into or stays at.

In some implementations, channel data samples may be accumulated, stored, and processed preferably at a central device which may have more powerful computation capability and larger storage space than a user device. However, channel data samples may be accumulated, stored, and processed optionally at a remote data center that is connected to the central device via a core network or Internet; or channel data samples may be accumulated, stored, and processed optionally at a user device, especially one that has a relatively powerful computational capability and large storage space.

At S602, the central device selects K channel data samples from M channel data samples to be K reference channels.

For example, the central device may select a set of K (K≤M) channel data samples from the M channel data samples [symbol] =[h₁ h₂ . . . h_{M}] to obtain [symbol] ₛₑₜ: [symbol] ₛₑₜ=[h_{Set(1)} h_{Set(2)} . . . h_{Set(K)}], where Set(k) returns the original index of the selected data sample in the [symbol] h. [symbol] _{Set} can be seen as an example of the set of reference channels mentioned in S520. Reference is made to the detailed description in S520 for the method of selecting K reference channels. Details are not described herein again.

In some scenarios, for example, the terabit multiple-input-multiple-output (T-MIMO) scenario, the dimension of reference channels (e.g., N_{dim}) may be very massive, and the central device may need to compress the reference channels, e.g., the set of reference channels [symbol] _{Set}, before transmitting them.

As mentioned in S520, the central device may compress the portion or all of the selected K reference channels and transmit the compressed reference channels to the user device. In some implementations, the central device may compress reference channels based on common information.

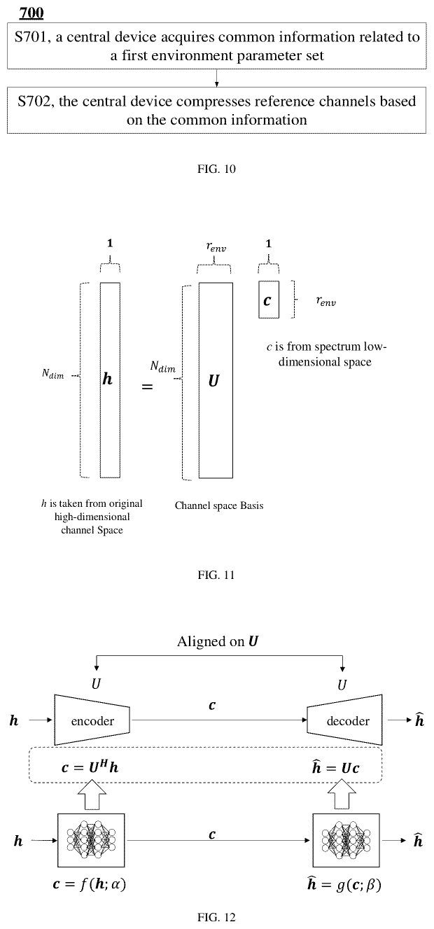

FIG. 10 shows a schematic flowchart of a method 700 that illustrates how a central device determines common information based on the first environment parameter set and compresses a reference channel to obtain a compressed reference channel, as mentioned in S520 of method 500. The method 700 can be executed before S520. The method 700 includes steps S701 and S702.

At S701, the central device acquires common information of the first environment parameter set.

For example, the common information may be generated by the central device based on M channel data samples. For another example, the common information is generated by a powerful user device, a remote data center, or other central devices, and is then transmitted to the central device. Reference is made to the detailed description in S601 for the method of accumulating M channel data samples. Details are not described herein again.

In practice, the channel data samples may be accumulated by combining the above alternative approaches mentioned in S610 in a dynamic manner. Different ways of accumulating channel data samples may result in different M channel data samples, and different M channel data samples may lead to different common information. For example, at the first stage in which there is no channel data sample at all, a first set of M channel data samples can be accumulated and prepared in the third approach mentioned in S601, and first common information can be determined based on the first set of M channel data samples. Then a second set of M channel data samples may be accumulated and prepared by using the first approach and/or the second approach during the second stage. Second common information can be determined based on the second set of M channel data samples, or the first common information may be refined to the second common information by the second set of M channel data samples. In addition, physical reference user devices of the second approach may detect some significant changes related to a targeted environment parameter set. The significant changes related to the targeted environment parameter set may trigger the third round of refining the second common information to third common information. The central device may decide which stage the system enters into or stays at.

Common information may be represented in various forms including but not limited to: one or more statistical functions with arguments; one or more matrices; one or several trained artificial intelligence (AI) models, for example, deep neural networks (DNNs).

For example, M channel data samples may be

$$= [ {h}_{1} {h}_{2} … {h}_{M} ] or = [ \begin{matrix}{h}_{1} \\ ⋮ \\ {h}_{M}\end{matrix} ]$$

mentioned in the method 600. The following disclosure presents [symbol] =[h₁ h₂ . . . h_{M}] as an example of M channel data samples.

In some implementations, common information is based on a matrix. For example, common information can be represented by a matrix, and then the following operation may be performed to compute the common information.

A device mentioned above, such as the central device, a powerful user device, a remote data center, other central devices, may decompose the matrix [symbol] as shown in FIG. 9. If M channel data samples are vectorized into column-wise vectors, the juxtaposition may be done column by column; if M channel data samples are vectorized into row-wise vectors, the juxtaposition may be done row by row. The two juxtapositions are mathematically equivalent. In the following discussion, column-wise vectorization and column-wise juxtaposition are used as examples. The decomposition may be to compute a basis of the matrix. The basis may be called a channel space basis to represent the common information acquired from the M channel data samples. The decomposition may be singular vector decomposition (SVD)-based so that the generated channel space basis is an orthonormal matrix or unitary matrix. The decomposition may be performed in accordance with a different method, resulting in the generated channel space basis being a non-orthogonal matrix.

The decomposition is a rank-reduced SVD: [symbol] =UΣV^{H}, where U is a N_{dim}-by-rₑₙᵥ unitary (or orthonormal) matrix. If h is set as a column-wise vector, U is the channel space basis and represents common information that all the M channel data samples share. If h is set as a row-wise vector, V is the channel space basis and represents common information of channels. In the following discussion, we will use the column-wise vector version.

The device that computes the channel space basis U from a plurality of channel data samples may project each vectorized channel data sample h by inverse of the channel space basis U-1 into an equivalent low-dimensional space representation c, which may be known as a low-dimensional spectrum coefficient representation: c=U⁻¹h, where c is a rₑₙᵥ-by-1 vector. If the channel space basis U is an orthonormal matrix or unitary matrix, then the inverse of the channel space basis U⁻¹ is Hermitian transpose of the channel space basis (U⁻¹=U^{H}): c=U^{H}h. Because c contains all the principal information of h, the device may project the spectrum coefficient representation back to the original channel data space: h=Uc, as illustrated in FIG. 11. The device may prefer storing channel data samples in the form of the low-dimensional space representation c with a channel space basis U, rather than in the form of the vectorized number of channel data samples h.

In some other implementations, common information is based on AI. For example, common information can be represented by an AI model. The following operation may be taken to compute the common information.

As shown in FIG. 12, the device may use a non-linear encoding function c=ƒ(h; α) (α is the tunable parameter), which approximates c=U⁻¹h, and use a non-linear decoding function h=g(c; β) (β is the tunable parameter), which approximates h=Uc. The non-linear encoding function and non-linear decoding function may be concatenated into ĥ=g(ƒ(h; α); β) and may be realized by a DNN with α and β as tunable neurons. In the DNN-like implementation, the device may choose the output of one latent layer (c=ƒ(h; α)) for an equivalent low-dimensional space of the input h.

The device may train the DNN by a learning goal to minimize MSE ∥h₁−g(ƒ(h₁;α); β)∥² for all the M channel data samples (h₁, h₂, . . . , h_{M}) in a stochastic gradient descent (SGD) way to tune the parameters α and β.

S702, the central device compresses reference channels based on the common information.

The common information can be seen as an example of information indicating the compression function mentioned in the method 500.

For example, the compression function may be built from the common information. The compression function may be represented as compress( ). compress(reference channel) represents using common information to process or compress reference channels, and a result of compress(reference channel) is the compressed reference channel.

The central device compresses reference channels based on the compression function. Furthermore, in an example, the compression function is built from the common information.

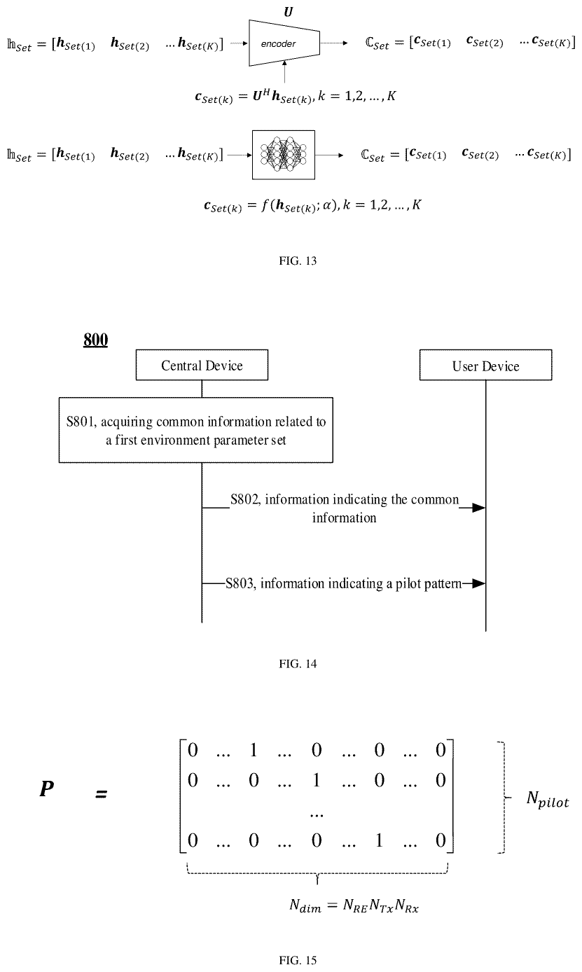

For example, if the common information is represented in a matrix model, the central device may project the set of reference channels [symbol] _{Set} into a low-dimensional spectrum coefficient vector by c_{Set(k})=U^{H}h_{Set(k)}, k=1, 2, . . . , K. The central device may store the set of reference channels in low-dimensional spectrum space as [symbol] _{Set}=[c_{Set(1)} c_{Set(2)} . . . c_{Set(K})], where c_{Set(k)} is a rₑₙᵥ-by-1 vector instead of in the original space [symbol] _{Set}=[h_{Set(1)} h_{Set(2)} . . . h_{Set(K)}]. If the common information is represented in an AI model, the central device may use the AI model to project the set of reference channels [symbol] _{Set} into low-dimensional space [symbol] _{Set} as shown in FIG. 13. U^{H}h_{Set(k)} can be seen as an example of compress (reference channel), where U^{H} is common information, h_{Set(k)} is a reference channel, and U^{H} can be replaced by another form common information.

In order for the user device to determine one or more reference channels mentioned in method 500, the user device needs to acquire the pilot pattern and/or the common information related to the first environment parameter set.

FIG. 14 shows a schematic flowchart of a method 800 that illustrates how the user device acquires the pilot pattern and the common information related to the first environment parameter set. The method 800 may be executed synchronously with S520. The method 800 includes steps S801 to S803.

At S801, the central device acquires the common information related to the first environment parameter set.

Reference is made to the detailed description in S701 for the method of acquiring the common information. Details are not described herein again.

For example, the central device may have a channel space basis U mentioned in the method 700 to represent the common information for the first environment parameter set. The central device may apply the channel space basis U to a radio channel between the central device and a user device that may be related to the first environment parameter set, or the central device may inform the user device of the channel space basis U so that the user device may apply the channel space basis U to the radio channel between the central device and the user device.

Any device that has the channel space basis U may project the channel estimation to obtain a channel estimation result ĥᵤₛₑᵣ (N_{dim}-by-1, N_{dim}=N_{RE}N_{Tx}N_{Rx}) of the radio channel into a low-dimensional spectrum coefficient vector ĉᵤₛₑᵣ (rₑₙᵥ-by-1) subject to ĥᵤₛₑᵣ=Uĉᵤₛₑᵣ and ĉᵤₛₑᵣ=U⁻¹ĥᵤₛₑᵣ. If the channel space basis U is orthonormal or unitary, hᵤₛₑᵣ=Ucᵤₛₑᵣ and cᵤₛₑᵣ=U^{H}hᵤₛₑᵣ. Therefore, the central device may configure or inform the user device of the channel space basis U or vice-versa.

At S802, the central device transmits information indicating the common information to the user device.

The user device can also receive the common information related to the first environment parameter set from another device such as a remote data center, a powerful user device, or other central devices. The common information may be generated by the user device when the user device is powerful enough.

At S803, the central device transmits information indicating the pilot pattern to the user device.

In some implementations, a pilot pattern can be represented by a Nₚᵢₗₒₜ-by-N_{dim} matrix P as shown in FIG. 15, each row of which has only one “1” to indicate the position to be used as pilot, where Nₚᵢₗₒₜ-by-N_{dim} represents matrix P is with Nₚᵢₗₒₜ rows and N_{dim} columns. The central device may transmit pilots on these positions indicated by the matrix P. The user device may estimate the channel coefficients on these positions indicated by the matrix P, and obtain a channel estimation result ĥₚᵢₗₒₜ_{ᵤₛₑᵣ} (represented by Nₚᵢₗₒₜ-by-1). The matrix P may also be explicit or implicit in other forms.

The central device and the user device may use a non-uniform and sparse pilot pattern, meaning Nₚᵢₗₒₜ<<N_{dim}, which may reduce pilot overhead.

For example, a near-optimal non-uniform pilot pattern can be computed by pivot “QR” decomposition (QRD) on a channel space basis U: UP=QR. The several “strongest” pivots in P (in typical pivot QRD, the pivots are ordered in terms of their importance or contributiveness) would indicate the most important or contributive positions to place reference signals (or pilots) for the reconstruction purpose.

To obtain the channel estimation result ĥᵤₛₑᵣ, which is used for the user device to determine the one or more reference channels from the first set of reference channels, both the central device and the user device may be configured with a same pilot pattern. In implementations where the central device may transmit the matrix P to the user device, there may be other alternatives such as the following.

In some implementations, both the central device and the user device may follow a legacy uniform pilot pattern defined in a wireless standard. In the 5G-NR specification for example, every RB has 1 pilot and pilots are constantly placed across the RB direction. Both the central device and the user device may use a minimum controlling payload to align the parameters about the uniform pilot pattern. Both the central device and the user device may configure or inform each other to have the channel space basis U. The central device may send the pilots on the positions that the matrix P may indicate, and the user device may receive the pilots on the positions that the matrix P may indicate. The user device may estimate the radio channel from the received pilots and obtain the channel estimation result ĥᵤₛₑᵣ. Then, the user device projects the channel estimation result ĥᵤₛₑᵣ to the low-dimensional spectrum coefficient vector ĉᵤₛₑᵣ. The user device may transmit the low-dimensional spectrum coefficient vector ĉᵤₛₑᵣ to the central device, and the central device may receive and project the low-dimensional spectrum coefficient vector ĉᵤₛₑᵣ back to the original channel space (ĥᵤₛₑᵣ=Uĉᵤₛₑᵣ) by the channel space basis U.

In some other implementations, both the central device and the user device may follow a random function that generates a random pilot pattern in terms of a given random seed(s), where the random function may be defined in a wireless standard. Both the central device and the user device may use a minimum controlling payload to align the parameters about the random function and random seed and other arguments. Both the central device and the user device may configure or inform each other to have the channel space basis U. The central device may send the pilots on the positions that the matrix P may indicate, and the user device may receive the pilots on the positions that the matrix P may indicate. The user device may estimate the radio channel from the received pilots and obtain the channel estimation result ĥᵤₛₑᵣ. Then, the user device projects the channel estimation result ĥᵤₛₑᵣ to the low-dimensional spectrum coefficient vector ĉᵤₛₑᵣ. The user device may send the low-dimensional spectrum coefficient vector ĉᵤₛₑᵣ to the central device, and the central device may receive and project the low-dimensional spectrum coefficient vector ĉᵤₛₑᵣ back to the original channel space (ĥᵤₛₑᵣ=Uĉᵤₛₑᵣ) by the channel space basis U.

In some other implementations, both the central device and the user device may follow a generative function that generates a pilot pattern in terms of the channel space basis U, where the generative function may be defined in a wireless standard. Both the central device and the user device may use a minimum controlling payload to align the parameters about the generative function and other arguments. Both the central device and the user device may configure or inform each other to have the channel space basis U. The central device may send the pilots on the positions that the matrix P may indicate, and the user device may receive the pilots on the positions that the matrix P may indicate. The user device may estimate the radio channel from the received pilots and obtain the channel estimation result ĥᵤₛₑᵣ. Then, the user device projects the channel estimation result ĥᵤₛₑᵣ to the low-dimensional spectrum coefficient vector ĉᵤₛₑᵣ. The user device may transmit the low-dimensional spectrum coefficient vector ĉᵤₛₑᵣ to the central device, and the central device may receive and project the low-dimensional spectrum coefficient vector ĉᵤₛₑᵣ back to the original channel space (ĥᵤₛₑᵣ=Uĉᵤₛₑᵣ) by the channel space basis U.

In some other implementations, both the central device and the user device may follow a generative AI model that generates a pilot pattern. Both the central device and the user device may use a minimum controlling payload to align the parameters about the generative AI model and other arguments. Both the central device and the user device may configure or inform each other to have the channel space basis U. The central device may send the pilots on the positions that the matrix P may indicate, and the user device may receive the pilots on the positions that the matrix P may indicate. The user device may estimate the radio channel from the received pilots and obtain the channel estimation result ĥᵤₛₑᵣ. Then, the user device projects the channel estimation result ĥᵤₛₑᵣ to the low-dimensional spectrum coefficient vector ĉᵤₛₑᵣ. The user device may transmit the low-dimensional spectrum coefficient vector ĉᵤₛₑᵣ to the central device. The central device may receive and project the low-dimensional spectrum coefficient vector ĉᵤₛₑᵣ back to the original channel space (ĥᵤₛₑᵣ=Uĉᵤₛₑᵣ) by the channel space basis U.

If the channel space basis U is generated by the AI model (for example a DNN), both the central device and the user device should be aligned with ƒ(; α) and g(; β) in S701.

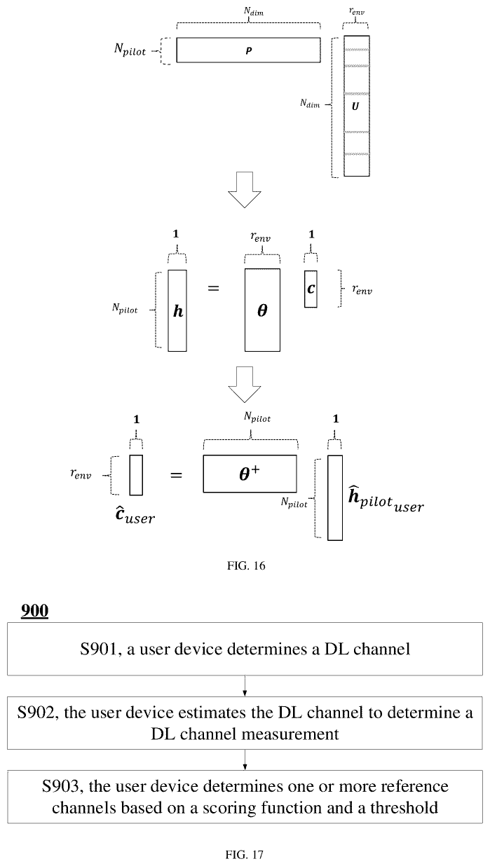

In some possible implementations, as shown in FIG. 16, both the central device and the user device may use the matrix P to down-sample the channel space basis U (N_{dim}-by-rₑₙᵥ) into a Nₚᵢₗₒₜ-by-rₑₙᵥ θ subject to θ=PU. If the matrix P defines a sparse pilot pattern (Nₚᵢₗₒₜ<<N_{dim}), then the matrix θ is much smaller than the channel space basis U. Thus, the matrix θ can be seen as a compact channel space basis. A sparse down-sampling (Nₚᵢₗₒₜ<<N_{dim}) is a hash function to ensure that no one can reconstruct the channel space basis U from the matrix θ. Thereby, both the central device and the user device may take the matrix θ as an alternative to the channel space basis U, and the central device may configure and inform the user device of the matrix θ instead of the channel space basis U.

The user device may obtain the low-dimensional spectrum coefficient vector (ĉᵤₛₑᵣ) directly from the channel estimation on the received pilots:

$${\hat{c}}_{user} = {U}^{H} {\hat{h}}_{{pilot}_{user}} = {( {θ}^{H} θ )}^{- 1} {θ}^{H} {\hat{h}}_{{pilot}_{user}} = {θ}^{+} {\hat{h}}_{{pilot}_{user}} ,$$

where θ⁺ is a left pseudo inverse matrix of θ. θ⁺ is a right pseudo inverse matrix of 0 when the common information is represented by a row-wise vector-based basis such as V. Optionally, the central device may configure and inform the user device of the matrix θ⁺ instead of the channel space basis U. Matrix θ and matrix θ⁺ are other forms of the aforementioned common information.

In some implementations, to minimize pilot and channel measurement feedback overheads, both the central device and the user device are preferably aligned by a random-seed, a pseudo-random generative pilot placement function, and θ⁺. In a T-MIMO scenario, a BS, as a central device, would broadcast or multicast a common pilot pattern by a random seed and θ⁺ in a DL channel as controlling payload, and transmits the pilots according to the common pilot pattern. Candidate UEs, as user devices, will obtain the common pilot pattern and inverse matrix of compact channel space basis θ⁺, demodulate the pilots according to the pilot pattern, estimate the channel coefficients on the pilot signals, and compute the spectrum coefficients ĉᵤₛₑᵣ in terms of the channel estimation on the pilots. Optionally, the user device could transmit feedback information indicating the spectrum coefficients ĉᵤₛₑᵣ to the central device in UL as controlling payload immediately after obtaining the spectrum coefficients.

In some above embodiments, the central device has been shown as a transmitting apparatus and the user device has been shown as a receiving apparatus. In some other embodiments, the user device is a transmitting apparatus and the central device is a receiving apparatus.

The following examples illustrate how the user device selects the one or more reference channels mentioned in method 500 in conjunction with FIG. 17, which shows a schematic flowchart of a method 900. The method 900 may be executed after S520. The method 900 includes steps S901 to S903. The following disclosure presents the matrix P mentioned in the method 800 as an example of the pilot pattern, and presents matrix θ⁺ mentioned in the method 800 as an example of the common information related to the first environment parameter set.

At S901, the user device determines a DL channel.

For example, the DL channel can be viewed as an example of the DL channel in the method 500.

For example, the central device may transmit the pilots on the positions indicated by the matrix P in the DL channel.

At S902, the user device estimates the DL channel to determine a channel measurement.

In some implementations, the user device estimates the channel coefficients on the Nₚᵢₗₒₜ pilots whose positions are indicated by the matrix P on the DL channel and obtains a channel estimation result ĥₚᵢₗₒₜ_{ᵤₛₑᵣ} represented as a Nₚᵢₗₒₜ-by-1 vector. The user device may compute the low-dimensional spectrum coefficients ĉᵤₛₑᵣ by ĥₚᵢₗₒₜ_{ᵤₛₑᵣ} and θ⁺: ĉᵤₛₑᵣ=θ⁺ĥₚᵢₗₒₜ_{ᵤₛₑᵣ}. The low-dimensional spectrum coefficients can be seen as an example of the channel measurement of the user device's DL channel.

At S903, the user device determines the one or more reference channels based on a scoring function and a threshold.

In the present application, a device, either a central device or a user device, may measure or score the distance, similarity, or correlation between two reference channels by one or several scoring functions. The device may measure or score the distance in equivalent low-dimensional space.

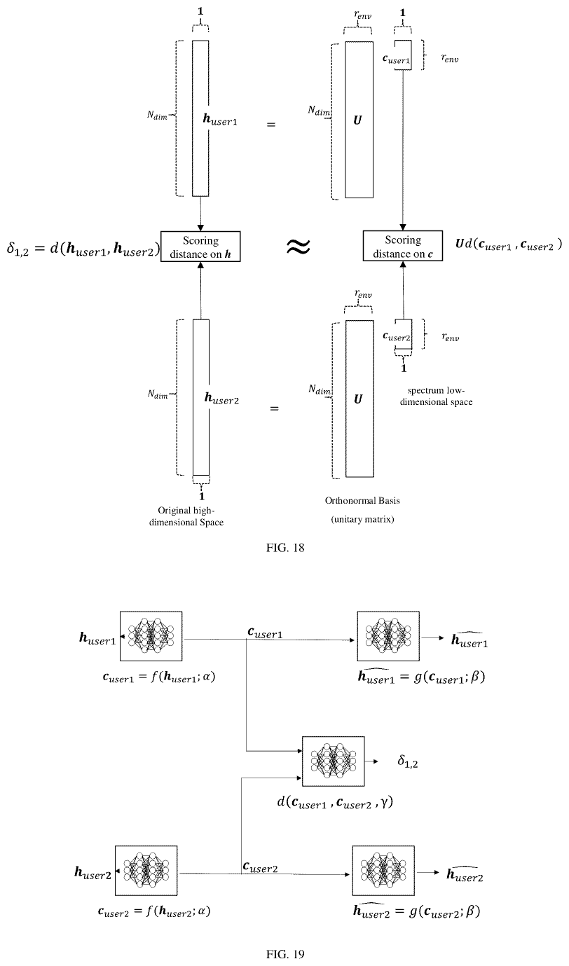

In case that the device represents common information by the channel space basis U, the device may project a reference channel hᵤₛₑᵣ (N_{dim}-by-1, N_{dim}=N_{RE}N_{Tx}N_{Rx}) into a low-dimensional spectrum space. For example, the device projects the reference channel hᵤₛₑᵣ into a spectrum coefficient vector cᵤₛₑᵣ (rₑₙᵥ-by-1) by the channel space basis U subject to hᵤₛₑᵣ=Ucᵤₛₑᵣ and cᵤₛₑᵣ=U⁻¹hᵤₛₑᵣ. In particular, when the channel space basis U is orthonormal or unitary, hᵤₛₑᵣ=Ucᵤₛₑᵣ and cᵤₛₑᵣ=U^{H}hᵤₛₑᵣ. Therefore, the device may score or measure the distance (or similarity, or correlation) metric between any two reference channels, e.g., hᵤₛₑᵣ₁ and hᵤₛₑᵣ₂, by a scoring function δ_{1,2}=d(hᵤₛₑᵣ₁, hᵤₛₑᵣ₂), which returns the distance (or similarity, or correlation) scalar metric between two input reference channels, hᵤₛₑᵣ₁ and hᵤₛₑᵣ₂. If d( ) is equivariant, then δ_{1,2}=d(hᵤₛₑᵣ₁, hᵤₛₑᵣ₂)=d(Ucᵤₛₑᵣ₁, Ucᵤₛₑᵣ₂)=Ud(cᵤₛₑᵣ₁, cᵤₛₑᵣ₂) as shown in FIG. 18, meaning that the distance can be equivalently measured on the low-dimensional spectrum space. The device may use d(cᵤₛₑᵣ₁, cᵤₛₑᵣ₂) to represent the distance between two reference channels (hᵤₛₑᵣ and hᵤₛₑᵣ₂).

In case the device represents common information by ƒ(: ; α), the device may use a scoring function on the latent layer output c=ƒ(h; α). As a result, the scoring function may be realized by another DNN (δ_{1,2}=d(cᵤₛₑᵣ₁, cᵤₛₑᵣ₂, γ)) as shown in FIG. 19, where γ are parameters in neurons needed to be trained.

In some implementations, one reference channel can be replaced by a DL channel in the scoring function to determine the distance between a reference channel and the DL channel. For example, the user device may determine the one or more reference channels by the given scoring function d( ) and common threshold δ_{threshold}:

$${ref}_{user} = {\underbrace{argmin}}_{j = Set ( 1 ) , Set ( 2 ) , … , Set ( K )} ( d ( {\hat{c}}_{user} , {c}_{j} ) \leq {δ}_{threshold} ) ,$$

where ĉᵤₛₑᵣ represents channel measurement of the DL channel, cⱼ represents a reference channel in the first set of reference channels, and one or more refᵤₛₑᵣ are examples of the reference channel reported by the user device in method 500. If none is found, refᵤₛₑᵣ is null which means there is no reference channel at a distance less than or equal to δ_{threshold} from the DL channel.

The scoring function d( ) can be seen as an example of the first scoring function as mentioned above in the method 500. The common threshold δ_{threshold} can be considered as an example of the first threshold as mentioned above in the method 500.

The user device may search the closest reference channel, the second closest reference channels and the third closest reference channels, etc., based on the given scoring function d( ) and common threshold δ_{threshold}.

In some implementations, for the purpose of determining the one or more reference channels from the set of reference channels, the user device (e.g., UE) may receive from the central device (e.g., BS) the pilot pattern (e.g., P mentioned in the method 800), the common information related to the first environment parameter set (e.g., U mentioned in the method 700, θ, or θ⁺ mentioned in the method 800), the set of reference channels (e.g., [symbol] _{Set} mentioned in the method 600, [symbol] _{Set} or [symbol] ′_{Set} mentioned in the method 700), the scoring function (e.g., d( ) defined above) and the first threshold (e.g., δ_{threshold}). For example, the central device may transmit θ⁺, P, [symbol] _{Set}, d( ) and δ_{threshold} to the user device implicitly or explicitly (e.g., pre-negotiation) in one time or several times by any one of broadcasting, multicasting, or unicasting.

In one example, as shown in FIG. 20 the central device may separately or simultaneously transmit to the user device P, θ⁺ or other forms that can generate θ⁺, [symbol] _{Set}=[c_{Set(1)} c_{Set(2)} . . . c_{Set(K)}], the scoring function d( ) and the common threshold δ_{threshold} or its indicator.

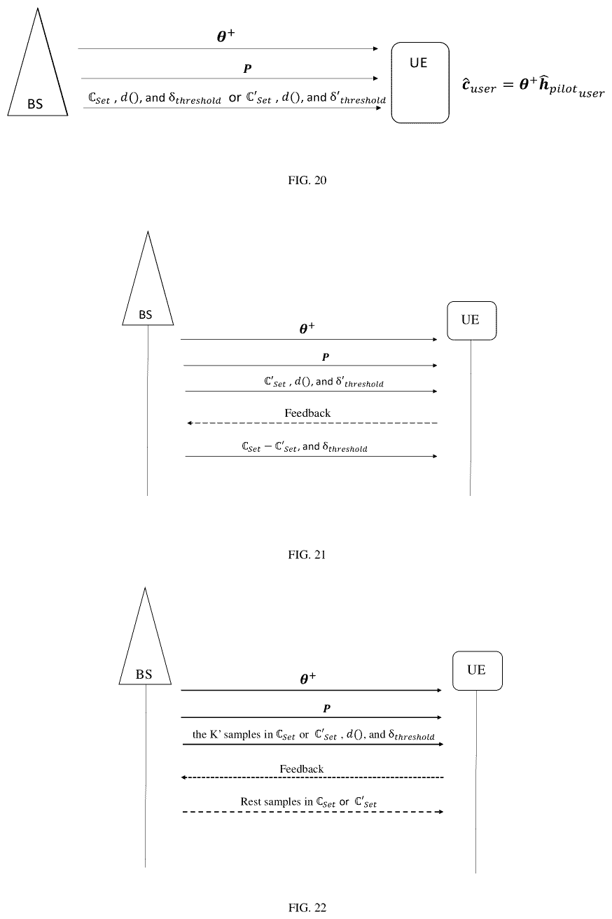

In another example, the central device may transmit a rank-reduced version of [symbol] _{Set}, i.e., the first r′ₑₙᵥ (r′ₑₙᵥ<rₑₙᵥ) elements of c_{Set(k)} instead of all the rₑₙᵥ elements of c_{Set(k)} to reduce DL payload. As shown in FIG. 21, the central device may separately or simultaneously transmit to the user device P, θ⁺ or other forms that can generate θ⁺, [symbol] ′_{Set}=[c′_{Set(1)} c′_{Set(2)} . . . c′_{Set(K)}], an indicator of r′ₑₙᵥ, the scoring function d( ) and a common threshold δ′_{threshold} or its indicator corresponding to r′ₑₙᵥ.

For example, the central device may transmit the first r′ₑₙᵥ (r′ₑₙᵥ<rₑₙᵥ) elements of c_{Set(k)} in the first transmission period, and then may transmit a portion or all of the rest rₑₙᵥ-r′ₑₙᵥ elements of c_{Set(k)} in the second transmission period. The central device may decide whether or not to make the second transmission based on feedback information from the user devices. For example, the central device may pre-define r′ₑₙᵥ and an interval between the first and second periods; or the central device may pre-define r′ₑₙᵥ, but waits for feedback information from the user devices to decide whether or not to transmit in the second transmission period; or the central device may broadcast or multicast in the first transmission period; and then it may multicast or unicast to a part of the user devices that transmit some specific feedback or no feedback in the second transmission period.

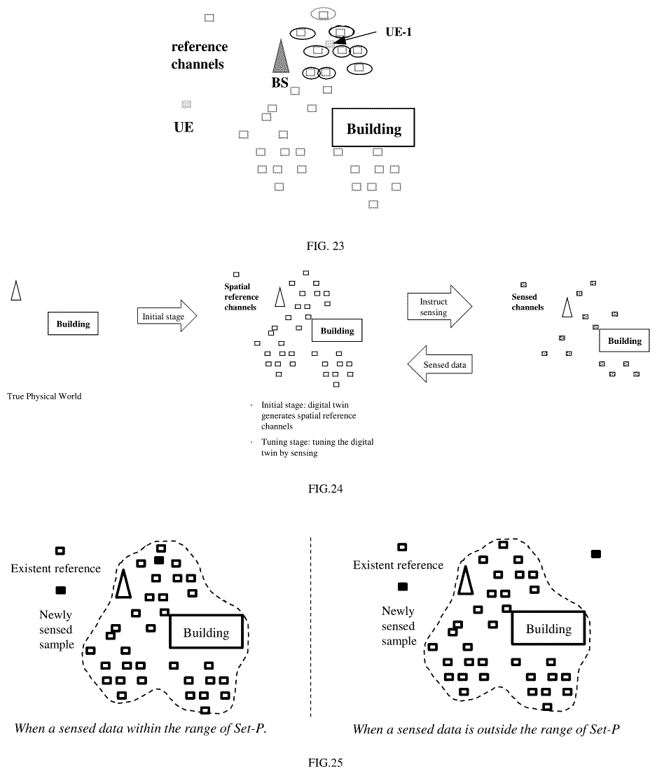

In yet another example, as shown in FIG. 22, the central device may transmit the first K′ reference channels in [symbol] _{Set} or [symbol] ′_{Set} in the first transmission period; and then may transmit a portion or all of the rest K-K′ reference channels in [symbol] _{Set} or [symbol] ′_{Set} in the second transmission period. The central device may decide whether or not to make the second transmission based on feedback from the user devices. For an example, the central device may randomly select K′ samples in [symbol] _{Set} or [symbol] ′_{Set} in the first transmission period. For another example, the central device may select the portion of [symbol] _{Set} based on channel condition related to a user device or the group of user devices. For still another example, if knowing the approximated position of a user device or positions of a plurality of the user devices, the central device may select some K′ reference channels in [symbol] _{Set} or [symbol] ′_{Set} based on the positions in the first transmission period, where the central device may select the reference channels closer to the user device or the group of the user devices. For example, reference channels shown on FIG. 23 are K reference channels. If UE-1 is one of user devices, the circled reference channels can be seen as an example of the K′ reference channels that are selected based on approximated position of UE-1.

In some scenarios, the central device may be related to a plurality of environment parameter sets. For example, [symbol] (band, area, weather, traffic, . . . ) is denoted as an environment parameter set as a function of factors such as the frequency band, the spatial area, the weather, the data traffic, the duplex mode, the time, the precoder and so on. Based on [symbol] , the central devices may represent the following for the given environment parameter set: a channel space basis [symbol] that indicates the common information; a matrix [symbol] that indicates the pilot pattern; a compact channel space basis [symbol] (or θ [symbol] ); a set of reference channels [symbol] ; a scoring function [symbol] ( ) and a common threshold [symbol] .

In possible implementations, there may be no channel data sample related to an environment parameter set [symbol] , but the central device could obtain a first model indicating a physical environment of a predetermined range associated to the central device, where the predetermined range associated with the central device could be considered as a spatial area related to the environment parameter set [symbol] .

For illustrative purposes, taking the scenario shown in FIG. 24 as an example, the following disclosure illustrates how to generate channel data samples. In FIG. 24, a building could form the physical environment with the predetermined range associated with the central device (e.g., BS). As shown in FIG. 24, it is assumed that there is no channel data sample related to an environment parameter set [symbol] at the beginning of the initial stage in FIG. 24. The central device could obtain a map that may indicate a position, a dimension and a surface material of the building.

As shown in FIG. 24, at initial stage, digital twin could generate a plurality of spatial reference channels, which could be considered as examples of virtual radio channels mentioned in method 500. The spatial reference channels could be used as channel data samples related to the environment parameter set [symbol] . Therefore, information related to the environment parameter set [symbol] , such as [symbol] , [symbol] ( ), [symbol] and so on, could be determined based on the channel data samples. The central device could select a set of reference channels, which could be considered as an example of the set of reference channels generated based on the first model and the second model mentioned in method 500, from the channel data samples. Moreover, the central device may determine a graph related to the environment parameter set [symbol] .

In some embodiments, critical vertices or critical reference channels could be identified. A critical vertices or critical reference channel could be related to a position on the graph related to the environment parameter set [symbol] , where the position on the graphs could be taken as examples of the first position mentioned in method 500. As shown in FIG. 24, the central device could transmit information to instruct physical reference user devices sensing radio channels around the critical vertices or critical reference channels. Correspondingly, sensing communication could be performed based on the information, which could be considered as an example of the fifth information in method 500. As a result, some sensed channels in FIG. 24 could be accumulated, and the central device could receive the sensed data indicating at least one of the sensed channels. The sensed channels could be considered as examples of the second reference channels mentioned in method 500. As shown in FIG. 24, at the tuning stage, the central device could tune the digital twin based on the sensed data. After the update of the digital twin, the virtual radio channels generated by the digital twin could be corrected, where a distance between a sensed channel and a corrected virtual radio channel generated by the updated digital twin could be less than or equal to a predetermined threshold. Moreover, the channel data samples related to the environment parameter set could be changed or updated. A set of reference channels could be determined based on the updated channel data samples. Moreover, a change (or an update) of the channel data samples may represent a change (or an update) of channel condition, which results in a change (or an update) of the environment parameter set. The information related to the updated environment parameter set could be determined based on the updated channel data samples. The procedure could be performed over a period time regularly or irregularly to update the digital twin and virtual radio channels.

In some embodiments, the feedback of the user device could be mapped back to the digital twin, and a position of the user device could be determined. As shown in the FIG. 25, a range in the dashed line could represent “range of Set-P” mentioned in FIG. 25, which could be taken as an example of a predetermined range associated to the central device (e.g., BS). The existent references in the FIG. 25 could represent channel data samples related to the predetermined range. A newly sensed sample in FIG. 25, which could be taken as an example of the second reference channel mentioned in method 500, could be mapped to the digital twin so that the position of user device could be determined. When the position of user device could be located in the predetermined range, as shown in the left part of FIG. 25, its feedback could be used to tune the digital twin. When the position of the user device is located outside the predetermined range, as shown in the right part of FIG. 25, the central device could discard the feedback of the user device.

In some embodiments, a plurality of channel data samples or reference channels related to an environment parameter set could be divided into one or more clusters (or groups). A cluster (or a group) could be considered as a subset of channel data samples or reference channels, related to a subset environment parameter set. For example, a set of channel data samples could include a plurality of virtual radio channels in a plurality of clusters. After an update of digital twin, virtual radio channels in a cluster generated by the updated digital may be corrected, where virtual radio channels in other clusters generated by the updated digital may remain unchanged. There may be a change for a corresponding subset environment parameter set, and a reference channel and information could be determined based on the changed subset environment parameter set.

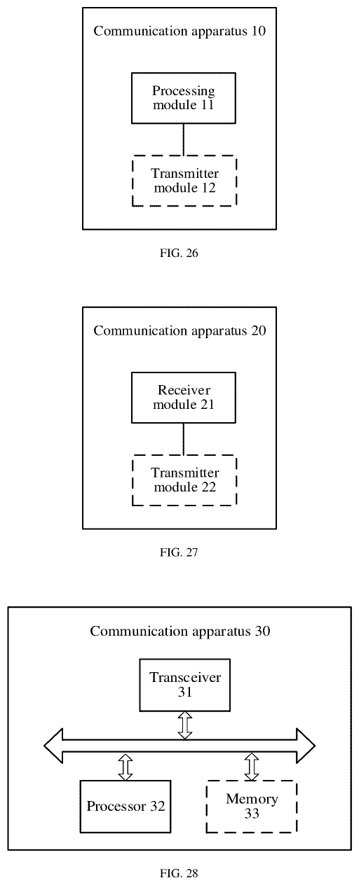

The communication method according to the embodiments of this application is described in detail above with reference to FIGS. 5-25, and the communication apparatus according to the embodiments of this application will be described in detail below with reference to FIGS. 26-28.

FIG. 26 is a schematic block diagram of a communication apparatus 10 according to an embodiment of this application. As shown in FIG. 26, the communication apparatus 10 includes:
a processing module 11, configured to obtain a first model and generate a set of reference channels based on a second model and the output of the first model, where the first model indicates a physical environment within a predetermined range associated with a central device, and the second model is determined based on a position of the central device and the first model.

In possible implementations, the communication apparatus 10 may further include: a transmitter module 12, configured to transmit first information indicating the set of reference channels and transmit second information used to determine one or more reference channels from the set of reference channels.

In possible implementations, the communication apparatus 10 may further include: a receiver module 13, configured to receive third information indicating the one or more reference channels, where the one or more reference channels include the first reference channel.

The communication apparatus 10 in this embodiment of this application may correspond to the central device in the communication method in the embodiments of this application described above. The foregoing management operations and/or functions and other management operations and/or functions of modules of the communication apparatus 10 are intended to implement corresponding steps of the foregoing methods. For brevity, details are not described herein again.

In possible implementations, the processing module 11 may be implemented by a processor. The transmitter module 12 in this embodiment of this application may be implemented by a transmitting apparatus.

In possible implementations, the transmitter module 12 and the receiver module 13 could be implemented by a transceiver.

FIG. 27 is a schematic block diagram of another communication apparatus 20 according to an embodiment of this application. As shown in FIG. 27, the communication apparatus 20 includes:
a receiver module 21, configured to receive first information indicating a set of reference channels where the first set of reference channel is determined based on a second model and an output of a first model.

In possible implementations, the communication apparatus 20 could further include: a transmitter module 22, configured to transmit third information indicating one or more reference channels in the set of reference channels. The distance between the first DL channel of user device and each of the one or more reference channels, could be less than or equal to a first threshold.

The communication apparatus 20 in this embodiment of this application may correspond to the user device in the communication method in the embodiments of this application described above, and the foregoing management operations and/or functions and other management operations and/or functions of modules of the communication apparatus 20 are intended to implement corresponding steps of the foregoing methods. For brevity, details are not described herein again.

In possible implementations, the receiver module 21 and the transmitter module 22 may be implemented by a transceiver.

As shown in FIG. 28 a communication apparatus 30 may include a transceiver 31. Optionally, the communication apparatus 30 may further include a processor 32 and/or a memory 33. The memory 33 may be configured to store indication information, or may be configured to store code, instructions, and the like that is to be executed by the processor 32.

The processor 32 may be an integrated circuit chip and have a signal processing capability. In an embodiment process, steps in the foregoing method embodiments can be implemented by using a hardware-integrated logical circuit in the processor, or by using instructions in the form of software. The processing module 11 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or a transistor logic device, or a discrete hardware component. All methods, steps, and logical block diagrams disclosed in these embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

It may be understood that the memory 33 in the embodiments of the present invention may be a volatile memory or a non-volatile memory, or may include a volatile memory and a non-volatile memory. The non-volatile memory may be a ROM, a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, and be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

An embodiment of this application further provides a system. The system includes: the central device and the user device in the foregoing embodiments.

An embodiment of this application further provides a computer storage medium, and the computer storage medium may store a program instruction for executing any of the foregoing methods.

Optionally, the storage medium may be specifically the memory 33.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a ROM, a RAM, a magnetic disk, an optical disc or the like.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

### A Method and Apparatus to Generate Spatial Reference Channels by Sensing System and Digital Twin

ACRONYMS AND ABBREVIATIONS

| Full Name | Acronym/Abbreviation/Initialism |
|---|---|
| MIMO | Multiple-In-Multiple-Out |
| T-MIMO | Terabit Multiple In and Multiple Out |
| NR | Next generation radio (=5G) |
| gNB | |
| BS | Base-station |
| UE | User-equipment |
| Tx | Transmitter |
| Rx | Receiver |
| SU | Single-User |
| MU | Multiple-User |
| RE | Resource Element |
| SVD | Singular Vector Decomposition |
| SNR | Signal-to-Noise Ratio |
| DL | Downlink |
| UL | Uplink |
| TDD | Time Division Duplex |
| FDD | Frequency Division Duplex |
| SRS | Sounding reference signals |
| TTI | Time Transmission Interval |
| RF | Radio Frequency |
| IF | Intermediate frequency |
| MAI | Multiple-Access-Interference |
| CSI-RS | Channel State Information Reference Signal |
| PMI | Precoding matrix index |
| RI | Rank index |
| Pivot-QRD | Pivot QR Decomposition |
| EZF | Eigen-Zero Forcing |
| MSE | Mean Square Error |
| LOS | Line of Sight |
| NLOS | Non Light of Sight |
| RT | Ray-Tracing |
| DNN | Deep Neural Network |
| RMS | Root-Mean-Square |
| AE | AutoEncoder |
| SGD | Stochastic Gradient Descendent |
| GMM | Gaussian Mix Model |

### MIMO and MU-MIMO

MIMO system has been widely deployed in modern wireless systems to improve system capacity and bandwidth efficiency by making use of space diversities among antenna ports. For example, on a given subcarrier or RE, a transmitter made of N_{Tx} Tx antenna ports and a receiver made of N_{Rx} Rx antenna ports consists into a N_{Rx}-by-N_{Tx} MIMO channel represented by a N_{Rx}-by-N_{Tx} complex matrix H_{UE,RE} that can be decomposed via SVD [4]: H_{UB,RE}=Z_{UE,RE}S_{UE,RE}V_{UE,RE}^{H}, where Z_{UE,RE} is a N_{Rx}-by-N_{Rx} square orthonormal matrix (s. t. Z_{UB,RE}^{H}Z_{UE,RE}=I), V_{UE,RE} is a N_{Tx}-by-N_{Tx} square orthonormal matrix (s.t. V_{UE,RE}^{H}V_{UE,RE}=I), and S_{UE,RE} is a N_{Rx}-by-N_{Tx} rectangular diagonal matrix. The rank (r_{UE,RE}) of H_{UE,RE} is no more than the smaller one between N_{Rx} and N_{Tx}, i.e. r_{UE,RE}=min(N_{Tx}, N_{Rx}). Per standard SVD, if the transmitter applied a precoder matrix V_{UE,RE} and the receiver a receiving matrix Z_{UE,RE}^{H}, the N_{Rx}-by-N_{Tx} MIMO channel would turn into r_{UE,RE} independent and parallel (orthogonal) sub-channels as following mathematic expression:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

Each sub-channel has a scale value channel response (h_{UE,RE}(i)), i.e. i-th diagonal element of S_{UE,RE} (singular value, h_{UE,RE}(i)=S_{UE,RE}(i, i)). Accordingly, SNR on the i-th sub-channel is defined as

$$\frac{{‖ {h}_{UE , RE} ( i ) ‖}^{2}}{N} , i = 1 , 2 , … , {r}_{UE , RE} .$$

In a wireless system, only the sub-channels whose SNRs are higher than a threshold are considered as effective for transmissions. The effective sub-channels are known as MIMO flows.

The SNR-based truncation MIMO decomposition scheme turns a standard SVD into a rank-reduced SVD one by discarding those sub-channels with SNRs lower than threshold(s): H_{UE,RE}≈Z_{UE,RE}S_{UE,RE}V_{UE,RE}^{H} (reduced SVD in [4]), where Z_{UE,RE} is a N_{Rx}-by-r_{UE,RE} orthonormal matrix (s.t. Z_{UE,RE}^{H}Z_{UE,RE}=I), V_{UE,RE} is N_{Tx}-by-r_{UE,RE} orthonormal matrix (s.t. V_{UE,RE}^{H}V_{UE,RE}=I), and S_{UE,RE} is r_{UE,RE}-by-r_{UE,RE} square diagonal matrix. The number of MIMO flows of H_{UE,RE} is r_{UE,RE}≤min(N_{Tx}, N_{Rx}). When the transmitter applied a precoder matrix V_{UE,RE} and correspondent receiver applied a receiving matrix Z_{UE,RE}^{H}, the N_{Rx}-by-N_{Tx} MIMO channel would become:

$${{Z}_{UE , RE}}^{H} {H}_{UE , RE} {V}_{UE , RE} = ( {{Z}_{UE , RE}}^{H} {Z}_{UE , RE} ) {S}_{UE , RE} ( {{V}_{UE , RE}}^{H} {V}_{UE , RE} ) = {S}_{UE , RE}$$

With reduced-rank SVD, S_{UE,RE} is a r_{UE,RE}-by-r_{UE,RE} diagonal matrix.

Mathematically speaking, the precoder matrix V_{UE,RE} at the transmitter and the receiving matrix Z_{UE,RE}^{H} at the receiver synergy the entire MIMO channel on the effective sub-channels by linear transformations over the MIMO channel H_{UE,RE}. MIMO gain or space diversity gain, indicated by SNRs

$$\frac{{‖ {h}_{UE , RE} ( i ) ‖}^{2}}{N} , i = 1 , 2 , … , {r}_{UE , RE} ,$$

is attributed to inherent space diversity of MIMO channel between transmitter and receiver, which is related to radio environment. Empirically, radio channels in such a complex environment as downtown environment would have higher number of MIMO flows than in a simple rural environment, because high buildings in downtown yield more space diversity by more radio reflectivity.

For higher MIMO gain, wireless systems increases the number of antenna ports, that is, N_{Tx} and N_{Rx}, which hoists the upper-bound of the number of potential MIMO flows, because of r_{UE,RE}≤min(N_{Tx}, N_{Rx}). But, in reality, r_{UE,RE} is far way smaller than its upper-bound, min(N_{Tx}, N_{Rx}). This motivates the deployment of MU-MIMO: if one MIMO channel from one user yields insufficient number of MIMO flows, several MIMO channels from multiple users could be multiplexed by a common precoder W. Imagine that two MIMO channels, H_{UE(1),RE} and H_{UE(2),RE}, on the same RE, are very different from each other; then it is likely to find a common precoder to multiplex (separate) both; whereas imagine that two MIMO channels, H_{UE(1),RE} and H_{UE(2),RE}, on the same RE, are almost the same; then it is unlikely to find a common precoder to multiplex (separate) both.

Mathematically, this common precoder W is related to precoders V_{UE(1),RE} and V_{UE(2),RE}. A widely used method in practice is based on EZF. Concatenate two precoders from reduced-SVD on MIMO channels into one by [symbol] =[V_{UE(1),RE} V_{UE(2),RE}] where z is a N_{Tx}-by-(r_{UE(1),RE}+r_{UE(2),RE}) matrix. In EZF way, their common precoder is W= [symbol] ( [symbol] ^{H} [symbol] )⁻¹ where W is a N_{Tx}-by-(r_{UE(1),RE}+r_{UE(2),RE}) matrix. If V_{UE(1),RE} and V_{UE(2),RE} are orthogonal to each other, [symbol] ^{H} [symbol] approaches an identity matrix, W= [symbol] z=[V_{UE(1),RE} V_{UE(2),RE}], meaning that the transmitter can continue using precoder matrix V_{UE(1),RE} for UE-1 and precoder matrix V_{UE(2),RE} for UE-2 to multiplex on this RE on the same time without MAI. If V_{UE(1),RE} and V_{UE(2),RE} are the same, [symbol] ^{H} [symbol] approaches a singular matrix (irreversible) so that no common precoder W is available. These two UEs cannot be paired together. In practice, most cases are between the two extremities. [symbol] ^{H} [symbol] is neither an identity matrix nor a singular matrix. Transmitter has to compute the common precoder for all the possible combinations and then find the best one. Unfortunately, it is a NP-hard problem. Suppose that a transmitter has 200 candidate receivers. In theory, this transmitter has to make an exhaustive search among

$${Σ}_{i = 2}^{200} ( \begin{matrix}i \\ 200\end{matrix} )$$

times different common precoder W computation for different combinations of receivers. Besides, in order to increase the extent to which [symbol] ^{H} [symbol] approaches an identity matrix and pair or group more receivers, we usually makes N_{Tx}>>Σᵢr_{UE(i),RE}, motivating wireless systems to adopt more antenna ports or more precisely higher MIMO antenna port ratio between transmitter and receiver (N_{Tx}/N_{Rx}).

After the common precoder W is computed, the transmitter would multiply it to its transmitted signals.

### MU-MIMO Engineering Tradeoffs

For a wireless system, MU-MIMO is usually used in DL, where BS is transmitter and UEs are receivers. MIMO channels of multiple UEs are paired by a common precoder W to multiplex on the same REs (frequency) and the same time durations (timing).

For higher throughput and system efficiency, modern MU-MIMO system deploys lots of antenna ports across a wider band. For example, in a T-MIMO system (of 6G), it is expected that BS has 3072 antenna ports and UE has 64 antenna ports over 400 MHz bandwidth. MIMO channel becomes a three-dimensional tensor (N_{RE}-by-N_{Rx}-by-N_{Tx}).

### Major Tradeoff #1: Assumption on DL/UL Channel Reciprocity

Although MU-MIMO should be paired over the DL channels between one BS and multiple UEs, it is impracticable for each candidate UE to report or feedback its DL channel estimation to the BS, because it would result into a huge UL feedback overhead due to the large dimensionality of T-MIMO channel. In TDD system, it is assumed that the DL channel between one BS and one UE can be approximated by the UL channel between the BS and the UE. In 4G and 5G-NR systems, SRS UL channel is specified for the UL channel measurement or estimation for this purpose. SRS UL channel is shared by a number of UEs. These UEs send their own SRS reference signals on the SRS pilot positions so that the BS can estimate their UL MIMO channels respectively. In 5G-NR, the sharing is achieved by coding multiplexing on modulation signals.

### Major Tradeoff-2: Random or Quasi-Random MU-Pairing Implementation

As aforementioned, MU-Pairing is a NP-hard problem. In theory, the optimal pairing is a result from an exhaustive search (computation) on all the possible combinations of the candidate UEs, from 2 of them up to all of them. However, the computation involving a pseudo-inversion of large matrix [symbol] is too long for a real-time signal processing during one TTI or several TTIs. In particular, when N_{Tx} is more than hundreds or even thousands and pairing 10 or 20 UEs in several TTIs, the pseudo-inversion of matrix z could become computation-wisely forbidden for most hardware implementation. Due to the complexity, storage and latency limitations, it is forbidden to exhaustively search the best pairing scheme in a practical implementation. Instead, some random or quasi-random selection of a fixed number of the paired UEs from a big pool of candidates is firstly conducted into z and then followed by a common precoder matrix EZF computation W= [symbol] ( [symbol] ^{H} [symbol] )⁻¹. Empirically, the selection may consider the positions of the candidate UEs. For example, an empirical selection algorithm may tend to choose the paired UEs far from each other, because it is more likely for these UEs to have orthogonal MIMO channels. For example, the number of the paired is simply given by empirical experience, system, or hardware limitations.

Strictly speaking, the tradeoff doesn't realize the pairing but only compute the precoder matrix W from whichever reversible [symbol] ^{H} [symbol] .

### Prior-of-Art: 5G-NR SRS UL and CSI-RS to Acquire DL MIMO Channels

5G-NR employs SRS UL channel to measure UL MIMO channels between BS (as transmitter) and multiple UEs (as receivers). BS would assume its measured or estimated UL MIMO channels from its SRS UL channel(s) as its DL MIMO channels between the BS and the UEs in TDD mode.

In details, SRS UL channel defines a set of uniform pilot (or reference signal) placement or position patterns in terms of RE (frequency), BS antenna ports, and UE antenna ports. The uniform pilot placement patterns are specified in the 5G-NR standards that both BS and UEs must comply with. One of the reasons to standardize uniform pilot placement patterns is its simplicity, that is, only a few of the parameters exchange both transmitter and receiver to align each other of the current pattern(s) to be used.

Moreover, in order for BS to measure more than one UE simultaneously, a coded multiplexing scheme is used over the pilots allowing more than one UEs to mask their pilots with different codes to share the same pilot positions. In 5G-NR, the coded multiplexing scheme on SRS UL channel is designed to accommodate up to 16 UEs. If there are more than 16 UEs requiring to share the SRS UL channel, new pilot positions have to be consumed. As a result, 5G-NR has a capacity for a SRS UL channel to measure a number of UEs simultaneously.

UL/DL channel is not always reciprocal, if RF and IF part are considered. For example, BS's RF component is designed for much higher Tx power than UE's RF one, resulting into DL coverage bigger than UL one, as show in FIG. 29.

The received UL signal strength from the UEs on the edge of a cell to the BS may be too weak to be estimated. These UEs have to feedback their DL MIMO channels rather than sending their pilots on SRS UL channel. Accordingly, 5G-NR provides them with CSI-RS, uniform pilot placement patterns, in DL channel(s). A UE would estimate the channel coefficients on the pilots (RS, reference signals) in the DL channels and then interpolate the entire channel coefficient from the estimated ones. The UE compresses the entire channel estimation into CSI and then feedbacks it to the BS in UL channel. 5G-standard defines not only the pilot placement pattern(s) for CSI-RS in DL channel but also the compression method. For example, CSI includes PMI and RI, both of which are the index in some pre-configured tables of precoding matrix and ranks. It is expected that the BS would decompress CSI into the DL MIMO channel estimation and then conduce the ensuing MU-MIMO pairing and common precoder computations. In general, CSI-RS DL channel result into CSI compression for a purpose of reconstruction; in specific, CSI compression or encoder specified in 5G-NR is a lossy compression.

### Prior-of-Art: MU-MIMO Pairing and Precoding Matrix Computation by EZF

As described in the background section, the pairing search and common precoder matrix computation are done together.

Firstly, the computation of the common precoding matrix cannot be done until all the SVDs on the candidate UEs are done. [symbol] =[V_{UE(1),RE} V_{UE(2),RE} . . . ]. Especially in T-MIMO, for each candidate UE, BS needs to estimate their MIMO channel H_{UE,RE} either from SRS UL channel or from CSI feedback, and then calculate rank-reduced SVD on a large number of N_{Rx}-by-N_{Tx} matrix.

Secondly, a pseudo-inversion operation of [symbol] ( [symbol] ^{H} [symbol] )⁻¹ would be too complicated to be finished in several mille-second duration. For example, in T-MIMO, [symbol] is a thousand-by-hundred complex matrix. Within one TTI (1 ms), it is nearly impossible to calculate [symbol] ( [symbol] ^{H} [symbol] )⁻¹ over a large number of candidate [symbol] .

### Prior-of-Art: Non-Uniform Pilot Placement Patterns

Both 5G-NR SRS UL Channels and CSI-RS DL channels employs uniform pilot placement patterns, partly because uniform pilot placement patterns are among the safest method to ensure channel estimation performance in particular with little prior-knowledge about the current channel, partly because they are easy to be described, standardized, and aligned (configured) across transceiver. However, uniform pilot placement patterns are one of the lowest efficient patterns. Its density must be designed for the worst case in statistics, which is rare in practice. In another word, uniform pilot placement patterns specified in the 5G-NR standard may as well be over-designed in most practical cases.

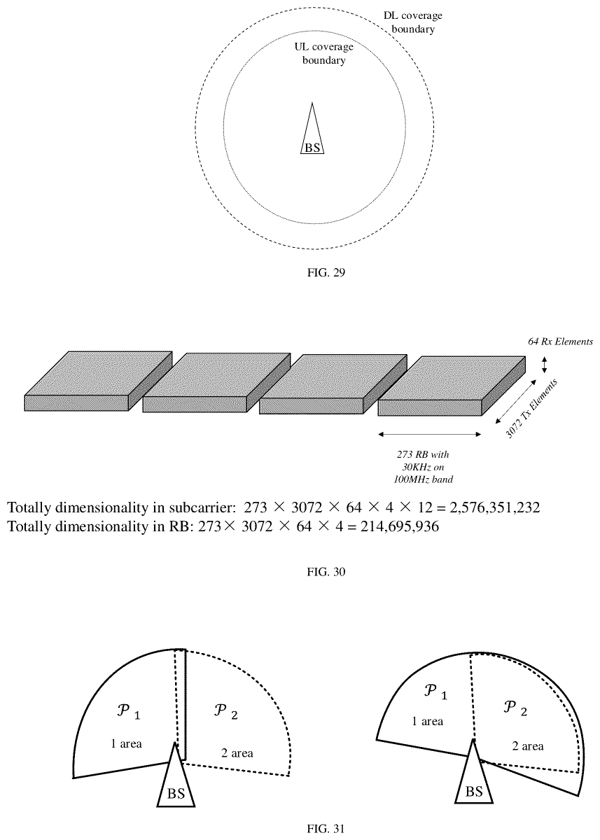

In 5G-NR, average density of its uniform pilot placement patterns is about 7%-17% of its radio resource to be used for pilots or reference signals. For example, one reference signal placed every RB (made of 12 consecutive REs) from one transmitter antenna port results into 8.33% (˜ 1/12) pilot overhead. As shown in FIG. 30, if TMIMO employed the same uniform density of 5G-NR, pilot overhead would be too heavy to be processed, or at least, forbid the UEs on the edge of a cell to feedback their T-MIMO CSI.

In theory, non-uniform pilot placement patterns based on prior-knowledge about distribution of a channel would consume much less pilot overhead. First of all, how is prior-knowledge learned and represented? In [2], it is invented that the prior-knowledge about a high-dimensional signal space (MIMO channel can be considered as high-dimensional signal space) is represented by an orthonormal channel space basis N_{dim}-by-rₑₙᵥ U (s.t. U^{H}U=I). N_{dim} is the total dimension after a signal space tensor is vectorized. (One column of U is one of the basis, meaning that any two columns of U are perfectly orthogonal to each other. In the IPR, we use the column as basis; it can be easily applied to that basis matrix whose rows are basis; simply U^{H}.) For example, the total dimension of a MIMO channel of N_{RE}-by-N_{Rx}-by-N_{Tx} is N_{dim}=N_{RE}N_{Rx}N_{Tx}. rₑₙᵥ is the rank of environment which is related to how complicated the prior-knowledge contain. In mathematics, rₑₙᵥ is the number of principal components of the prior knowledge.

[2] proposes to use data-learning method to learn the prior knowledge. The channel space basis U is computed from a number of data samples collected or sampled in the environment. [1] further proposes to apply this data-learning method in MIMO case where U is a representation of a common spatial prior-knowledge of MIMO channels within an environment of interest.

From the prior knowledge represented a common channel space basis (U), a near-optimal non-uniform pilot placement pattern can be computed by pivot QRD [3] on U: UP=QR. The several “strongest” pivots in P (in typical pivot QRD, the pivots are ordered in terms of their importance or contributiveness) would indicate the most important or contributive positions to place reference signals (or pilots) for the reconstruction purpose.

As shown in [1] and [2], non-uniform pilot placement pattern(s) indicated by pivots in P would result into near minimum pilot overhead but still minimize MSE [6] on the reconstruction (or decoder, decompression).

### Technical Solution in the Prior Art

Prior-of-Art: SRS-sounding UL channel
Prior-of-Art: CSI-RS DL channel
Prior-of-Art: EZF-based MU-MIMO Pairing and Precoder matrix computation
Prior-of-Art: QRD-based non-uniform pilot placement and compression

### Disadvantages of the Prior Art

### Prior-of-Art: 5G-NR SRS UL and CSI-RS to Acquire DL MIMO Channels

The first major disadvantage is due to the assumption about UL/DL channel reciprocity. Although the over-the-air part of a MIMO channel can typically meet UL/DL reciprocity thanks to information theory (I(X, Y)=I(Y,X), I(X, Y) is the mutual information of two random variable X and Y), the RF and IF components (analogy circuits) do not generally hold UL/DL reciprocity assumption. Thereby, the assumption would inevitably damage the overall performance. In addition, the assumption holds only in TDD mode but not in FDD mode. One column of U is one of the basis, meaning that any two columns of U are perfectly orthogonal to each other. In the IPR, we use the column as basis; it can be easily applied to that basis matrix whose rows are basis; simply U^{H}.

The second major disadvantage appears when the dimensions of MIMO channel go to such a great number as T-MIMO in FIG. 30. Firstly, BS has to estimate the entire MIMO channels for all the coded multiplexed UEs on its SRS UL channels. BS must estimate the channel coefficients on every single pilot for each coded multiplexed UE. Then, it must interpolate the entire MIMO channel from the estimated channel coefficients on the pilots for each UE. Secondly, it must try to pair all the active UEs and compute their common precoder. The dimensions of a typical T-MIMO makes storage and computation forbidden.

The third major disadvantage is due to MAI among coded multiplexed UEs sharing on the same SRS UL channel. MAI is inevitable. On one hand, it would limit the maximum number of the coded multiplexed UEs (capped capacity); on other hand, it would damage the accuracy (or performance) on the channel estimation. This is why 5G-NR has to limit the maximum number of UEs to share the same SRS UL channel. Nevertheless, the capped capacity on the SRS UL channel would present scheduling and overhead in 6G where much more active UEs would be accommodated by one BS than 5G-NR.

The fourth major disadvantage is due to the mobility. It is well-known that radio channel would change significantly when a UE is moving. Sometimes, even a small position displacement would cause a LOS loss, leading to a tremendous channel change. As SRS UL channel is shared among all active UEs and SRS UL channel has capacity cap, it is uneasy and power-consuming for a bunch of UEs and a BS to perform their SRS-UL channel estimations so frequently. Therefore, in practice, SRS-UL-based MU-MIMO is much sensitive to mobility.

The last major disadvantage is to involve DL CSI-RS channels for the UEs on the edge of the cell. In fact, UEs on the edge of a cell that uses CSI-RS would suffer from more severe performance loss.

### Prior-of-Art: MU-MIMO Pairing and Precoding Matrix Computation by EZF

The first disadvantage is due to the fact that [symbol] =[V_{UE(1),RE} V_{UE(2),RE} . . . ] must be calculated for any potential UE pairing possibility of all candidate UEs. If a candidate UE is not been selected for pairing on the current radio resource, the radio resource allocated to this UE (SRS UL channel or CSI-RS channel, and CSI feedback) and computation taken for this UE (channel estimation, SVD, decompression) are wasted.

The secondly disadvantage is due to the fact that a pseudo-inversion operation [5] of [symbol] ( [symbol] ^{H} [symbol] )⁻¹ must be calculated for any potential UE pairing possibility of all candidate UEs, which is widely used EZF method. If a set of protential UE paring [symbol] is not selected (only one set of UE pairing gets selected, the rest are discard for a certain radio time-frequency resource), computation and storage overhead ( [symbol] ( [symbol] ^{H} [symbol] )⁻¹) are wasted.

The final disadvantage is that the pairing procedure and precoder computation is sequential and bound together: for all potential UE pairing possibilities, ( [symbol] ( [symbol] ^{H} [symbol] )⁻¹) must be calculated for each potential UE pairing possibility, then a set of potential UE pairing could be selected as UE pairing applied on a certain radio time-frequency resources. The UE pairing applied on a certain radio time-frequency resources couldn't be decided before ( [symbol] ( [symbol] ^{H} [symbol] )⁻¹) for all the sets of potential UE pairing are tried.

### Prior-of-Art: ORD-Based Non-Uniform Pilot Placement and Compression

Although this method provides good channel estimation and compression scheme with near minimum pilot overhead and compression overhead, this is still for the purpose for a reconstruction of channel as reliably as possible. This purpose entails its minimum overheads in number of the reference signals and in compression ratio, both of which require a channel space basis (U). From source coding point of view, common channel space basis (U) is code book to minimize MSE in the reconstruction. How many rₑₙᵥ of N_{dim}-by-rₑₙᵥ U are kept determines how much “details” to be reconstructed. As channel space basis (U) is resultant of SVD [4] and SVD usually orders the columns of U in descendent of their corresponding singular values, the first column of U would be more important (more principal in mathematic term) than the second one and so on so forth. More columns kept in U would offer more “details” on the reconstruction but the “details” are less important from energy point of view.

In order to reconstruct the entire MIMO channel (H_{UE,RE}) by non-uniform pilot patterns (P), a big enough channel space basis (U) should be aligned between BS and UEs. Unfortunately, in TMIMO scenario, both U and P are in a huge amount. Further, when a UE moves from one environment to another, it must be updated from the current U and P to new U and P.

In some condition, channel space basis (U) is learned from a number of data samples, channel space basis (U) is itself a highly-IPR entity. It is costly to collect and clean data samples and compute channel space basis (U), especially data samples in a great dimension. Whoever with channel space basis (U) can optimize its non-uniform pilot patterns and even compression schemes.

### Detailed Descriptions of the Technical Solutions of the Present Invention

In the invention [8], a new method for MIMO pairing is proposed. Herein, a concept of spatial reference channels are used. BS, as transmitter, sends some spatial reference channels to UEs, as receivers. Instead of estimating, compressing, and feedbacking entire DL channel, a UE measures “distance” between its own estimated DL channel with a number of spatial reference channels, and then feedback only index of the closest reference channels to BS; after receiving indicators of closest reference channel from a plurality of UEs, BS conducts MU-MIMO pairing on in function of the indicators, and then requests selected UEs to send their channel estimation; finally BS computes total common precoder matrix for paired UEs in function of their feedback channels and indicators of closest reference channel.

How to generate training data set?

In the following discussions, we will use T-MIMO radio channel as an example because of its great dimensionality as illustrated in FIG. 30. In the following texts, we will abbreviate it into radio channels or channels. Remember that the very concept of spatial reference (mooring) channels can be applied to many great-dimensional signal space applications other than T-MIMO.

According to embodiment 1 of invention [8], a common (spatial) prior-knowledge about radio channels related to a specific environment can be acquired and learned in various forms in a data-driven way. According to embodiment 3 of the invention [8], one possible form to represent common prior-knowledge is an orthonormal basis U, an unitary matrix.

### FIG. 11: Equivalent Low-Dimensional Space.

Mathematically, with the channel space basis U, an original high-dimensional space signal h can be equivalently and linearly represented in a low-dimensional spectrum space c.

Channel space basis U allows to compress a reference channel to its spectrum space as described in Embodiment 8 of the invention [8]. A scoring function δ_{1,2}=d(hᵤₛₑᵣ₁, hᵤₛₑᵣ₂) is defined in Embodiment 5 of the invention [8] to allow all users to measure the distance between any two channels. More importantly, the scoring function can be done on low-dimensional spectrum space. Accordingly, a scoring function may be with a threshold δ_{threshold} as described in Embodiment 9 of the invention [8]. To save pilot overhead, Embodiment 6 of the invention [8] proposes a pilot placement pattern, i.e. a sampling matrix P, to indicate where pilots to be transmitted in DL channels. Moreover, pilot placement scheme is very sparse. More interestingly, sampling matrix P can further compress channel space basis U: θ=PU. Embodiment 6 of the invention [8] even suggests to directly send θ⁺ ((θ^{H}θ)⁻¹θ^{H}) to receivers.

Embodiment 7 of the invention [8] selects K spatial reference channels into a set: [symbol] _{Set}=[h_{Set(1)} h_{Set(2)} . . . h_{Set(K)}] based on their representativeness and then Embodiment 8 of the invention [8] compresses them into [symbol] _{Set}=[c_{Set(1)} c_{Set(2)} . . . c_{Set(K)}], where c_{Set(k)} is a rₑₙᵥ-by-1 vector. In Embodiment 9 of the invention [8], BS, as transmitter, sends (broadcast, multicast, or unicast) to UE implicitly or explicitly in one time or several times:

$${θ}^{+} , P , {ℂ}_{Set} , d ( ) , and {δ}_{threshold}$$

In Embodiment 9 of the invention [8], UE can firstly estimate the channel coefficients on the pilots ĥₚᵢₗₒₜ_{ᵤₛₑᵣ}; secondly compute ĉᵤₛₑᵣ=θ⁺ĥₚᵢₗₒₜ_{ᵤₛₑᵣ}; thirdly searches the closest reference channels:

$${ref}_{user} = {\underbrace{argmin}}_{j = Set ( 1 ) , Set ( 2 ) , … , Set ( K )} ( d ( {\hat{c}}_{user} , {c}_{j} ) \leq {δ}_{threshold} ) ,$$

none is found, refᵤₛₑᵣ is null.

The invention [8] mentions that there may be a plurality of sets of spatial reference channels, though it focuses on single set. In fact, a plurality of sets of spatial reference channels may originate from two different spatial environments, as described in the invention [9].

A BS, as either transmitter or receiver, can possess a plurality of common prior-knowledges related to a plurality of spatial environments or sub-environments:
Alternative #1: first common prior-knowledge for first spatial environment; second common prior-knowledge for second spatial sub-environment; first spatial environment and second spatial environment can be overlapping; or first spatial environment and second spatial environment can be non-overlapping;
Alternative #2: first common prior-knowledge for a spatial environment; second common prior-knowledge for first spatial sub-environment; third common prior-knowledge for second spatial sub-environment; first spatial sub-environment and second spatial sub-environment belong to the spatial environment; first spatial sub-environment and second spatial sub-environment can be overlapping; or first spatial sub-environment and second spatial sub-environment can be non-overlapping;

### FIG. 31: Prior Knowledge Corresponding to Environment and Sub-Environments.

A prior-knowledge [symbol] is a conceptual entity that can be embodied into:
A channel space basis [symbol] ;
A pilot placement matrix [symbol] and its compact channel space basis [symbol] (or θ [symbol] );
A set of reference channels [symbol] , a scoring function [symbol] ( ), and a common threshold

[symbol]

Moreover, according to Embodiment 11 of the invention [8], BS may have pairing graphs [symbol] =[d_{i,j,l}], i, j=1, 2, . . . , K, l=1, 2, . . . , N_{RBG} related to the prior-knowledge [symbol] . In sum, given a prior-knowledge [symbol] , BS may store pilot placement scheme, compact channel space basis, set of reference channels, scoring function, common threshold, and a number of pairing graph on each RBG. BS may have a plurality of prior-knowledges, each of which has pilot placement scheme, compact channel space basis, set of spatial reference channels, scoring function, common threshold, and a number of pairing graph on each RBG.

To avoid conceptual entity on prior-knowledge, we denote an entity [symbol] that includes:
A pilot placement matrix [symbol] and its compact channel space basis [symbol] (or θ [symbol] );
A set of reference channels [symbol] , a scoring function [symbol] ( ), and a common threshold

[symbol]

### Embodiment 1: Generating Channels Via Digital Twin

At the beginning, there is no data about a physical spatial environment but a 3D map that includes some dimensions and/or surface materials of surroundings such as buildings, bridges, pavements and so on.

A digital twin is based on famous ray-tracing model in which rays, groups of rays, clusters of paths are computed from the 3D models given the coordinates and configurations of BS for a position within this environment. The ray-tracing model would result into “virtual” radio channels.

By randomly selected positions on which a virtual radio channel is generated, M radio channels are accumulated: =[h₁ h₂ . . . h_{M}].

Following the method described in Embodiment 7 of the invention [8] way and Embodiment 2 of the invention [11], we will have a number of the prior-knowledges [symbol] and their Sets [symbol] .

### Embodiment 2: Identifying Most Representative Positions

According to the Embodiment 7 of the invention [8], some key vertices or reference channels are identified. Then, sensing communication is required to accumulated true channels around these key positions by the traditional way as mentioned in Embodiment 2 of the invention [8]. The new data would retire first virtually generated data. And in Embodiment 3 of the invention [11], it can partially and gradually update the prior-knowledges [symbol] and their Sets [symbol] .

This procedure keeps going on over a period time regularly or irregularly to “correct” virtual data generated by the digital twin. In this sense, sensing communication helps improve the accuracy of digital twin.

### FIG. 24: Using Sensing Communication to Correct Channels Generated by Digital Twin

Digital twin also identifies “outliers” of sensed data and then clean them. Sensed data will be evaluated in Digital twin and history data.

### FIG. 6: Cleaning New Data.

### Embodiment 3: Predicting with Digital twin

The feedbacks from a UE is mapped back to the digital twin, in which some trajectory predictor algorithm is applied. It will generate a predication about this UE to trigger the support for moving UE as described in the inventions [9] and [10].

### FIG. 25: Digital Twin can Estimate Positions of UE.

[1] PCT/CN2022/126878 A Method And Apparatus of Channel Estimation for MIMO System
[2] PCT/CN2022/094688 An Method to Design Transmission Dimensionality and Reference Signal Placement Scheme for a Dimensional Transmission Channel by its Prior Structures
[3] Pivot-QRD: https://en.wikipedia.org/wiki/QR_decomposition
[4] SVD: https://en.wikipedia.org/wiki/QR_decomposition
[5] Pseudo-Inverse: https://en.wikipedia.org/wiki/Moore % E2%80%93Penrose_inverse
[6] MSE: https://en.wikipedia.org/wiki/Mean_squared_error
[7] Condition number of matrix: https://en.wikipedia.org/wiki/Condition_number

### 6G System Structure

### 6G Basic Module Structure

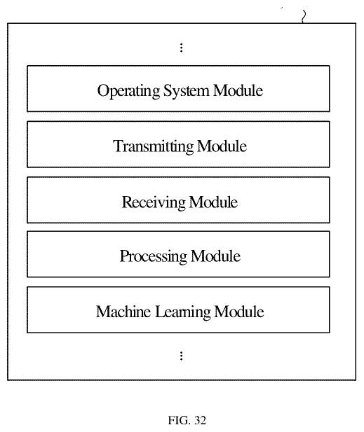

One or more steps of the embodiment methods provided herein may be performed by corresponding units or modules, according to FIG. 32. FIG. 32 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

What is claimed is:

1. A method, comprising:
obtaining a first model, wherein the first model indicates a physical environment within a predetermined range associated with a central device; and
generating a set of reference channels based on a second model and an output of the first model, wherein the second model is determined based on a position of the central device and the first model.

2. The method according to claim 1, further comprising:
transmitting first information indicating the set of reference channels; and
transmitting second information, wherein the second information is used to determine one or more reference channels from the set of reference channels.

3. The method according to claim 2, further comprising:
receiving third information indicating the one or more reference channels in the set of reference channels, wherein a distance between each of the one or more reference channels and a first downlink (DL) channel of a user device is less than or equal to a first threshold; and
determining a position of the user device based on a first reference channel and the second model, where the one or more reference channels comprises the first reference channel.

4. The method according to claim 1, further comprising:
receiving fourth information indicating a second reference channel, wherein the second reference channel is used to update the second model.

5. The method according to claim 4, further comprising:
transmitting fifth information based on a first position related to the second reference channel, wherein the fifth information indicates that a user device transmits the fourth information.

6. A method, comprising:
receiving first information indicating a set of reference channels, wherein the set of reference channels is generated based on a second model and an output of a first model, the second model is determined based on a position of a central device and the first model, and the first model indicates a physical environment within a predetermined range around a central device.

7. The method according to claim 6, further comprising:
transmitting third information indicating one or more reference channels in the set of reference channels, wherein a distance between each of the one or more reference channels and a first DL channel of a user device is less than or equal to a first threshold.

8. The method according to claim 6, further comprising:
receiving second information, wherein the second information is used to determine the one or more reference channels from the set of reference channels.

9. The method according to claim 6, wherein the one or more reference channels comprises a first reference channel, and a position of a user device is determined based on the first reference channel and the second model.

10. The method according to claim 6, further comprising:
transmitting fourth information indicating a second reference channel, wherein the second reference channel is used to update the second model.

11. An apparatus, comprising:
at least one processor coupled with at least one memory storing one or more instructions that are capable of being run on the at least one processor, wherein when the one or more instructions are run, the apparatus is enabled to:
obtain a first model, wherein the first model indicates a physical environment within a predetermined range associated with a central device; and
generate a set of reference channels based on a second model and an output of the first model, wherein the second model is determined based on a position of the central device and the first model.

12. The apparatus according to claim 11, wherein the apparatus is further enabled to:
transmit first information indicating the set of reference channels; and
transmit second information, wherein the second information is used to determine one or more reference channels from the set of reference channels.

13. The apparatus according to claim 12, wherein the apparatus is further enabled to:
receive third information indicating the one or more reference channels in the set of reference channels, wherein a distance between each of the one or more reference channels and a first downlink (DL) channel of a user device is less than or equal to a first threshold; and
determine a position of the user device based on a first reference channel and the second model, where the one or more reference channels comprises the first reference channel.

14. The apparatus according to claim 11, wherein the apparatus is further enabled to:
receive fourth information indicating a second reference channel, wherein the second reference channel is used to update the second model.

15. The apparatus according to claim 14, wherein the apparatus is further enabled to:
transmit fifth information based on a first position related to the second reference channel, wherein the fifth information indicates that a user device transmits the fourth information.

16. An apparatus, comprising:
at least one processor coupled with at least one memory storing one or more instructions that are capable of being run on the at least one processor, wherein when the one or more instructions are run, the apparatus is enabled to:
receive first information indicating a set of reference channels, wherein the set of reference channels is generated based on a second model and an output of a first model, the second model is determined based on a position of a central device and the first model, and the first model indicates a physical environment within a predetermined range around a central device.

17. The apparatus according to claim 16, wherein the apparatus is further enabled to:
transmit third information indicating one or more reference channels in the set of reference channels, wherein a distance between each of the one or more reference channels and a first DL channel of a user device is less than or equal to a first threshold.

18. The apparatus according to claim 16, wherein the apparatus is further enabled to:
receive second information, wherein the second information is used to determine the one or more reference channels from the set of reference channels.

19. The apparatus according to claim 16, wherein the one or more reference channels comprises a first reference channel, and a position of a user device is determined based on the first reference channel and the second model.

20. The apparatus according to claim 16, wherein the apparatus is further enabled to:
transmit fourth information indicating a second reference channel, wherein the second reference channel is used to update the second model.
